(19) United States
(12) Patent Application Publication
(10) Pub. No.: US 2025/0166609 A1
(43) Pub. Date: May 22, 2025

(54) TEXT SUMMARIZATION TECHNIQUES

(71) Applicant: Amazon Technologies, Inc., Seattle, WA (US)

(72) Inventors: Markus Dreyer, Seattle, WA (US); Sujith Ravi, Menlo Park, CA (US)

(21) Appl. No.: 19/033,851

(22) Filed: Jan. 22, 2025

Related U.S. Application Data
(63) Continuation of application No. 17/196,414, filed on Mar. 9, 2021.

(51) Int. Cl. G10L 13/08; G06F 16/34; G10L 15/16; G10L 15/197

(52) U.S. Cl. CPC G10L 13/08; G06F 16/345; G10L 15/16; G10L 15/197

(57) ABSTRACT

Techniques for generating a summary of text-based documents are described. A system may be configured to generate a summary with a certain level of originality as compared to the source document. The system may be provided a value indicating a number of consecutive words that can be copied from the source document, after which the system may copy words from another portion of the source document or generate original words to include in the summary. Different summaries may be generated using multiple documents relating to a particular entity, and one of the different summaries may be selected for output in response to a user input.

### CROSS-REFERENCE TO RELATED APPLICATION

This application is a continuation of, and claims the benefit of priority to, U.S. Pat. No. 17,196,414, filed Mar. 9, 2021, entitled “TEXT SUMMARIZATION TECHNIQUES”, which is hereby incorporated in its entirety by reference.

### BACKGROUND

Natural language processing systems have progressed to the point where humans can interact with computing devices using their voices and natural language textual inputs. Such systems employ techniques to identify the words spoken and typed by a human user based on the various qualities of received input data. Speech recognition combined with natural language understanding processing techniques enable speech-based user control of computing devices to perform tasks based on the user's spoken inputs. Speech recognition and natural language understanding processing techniques may be referred to collectively or separately herein as spoken language understanding (SLU) processing. SLU processing may be used by computers, hand-held devices, telephone computer systems, kiosks, and a wide variety of other devices to improve human-computer interactions.

### BRIEF DESCRIPTION OF DRAWINGS

For a more complete understanding of the present disclosure, reference is now made to the following description taken in conjunction with the accompanying drawings.

FIG. 1A is a conceptual diagram illustrating a system configured to generate summarized text data by processing multiple input text data, according to embodiments of the present disclosure.

FIG. 1B is a conceptual diagram illustrating a system configured to respond to a user input using summarized text data, according to embodiments of the present disclosure.

FIG. 2 is a conceptual diagram showing how a system may process multiple text data to generate summarized text data, according to embodiments of the present disclosure.

FIGS. 3A and 3B are conceptual diagrams showing how a summary generator component may generate the summarized text data, according to embodiments of the present disclosure.

FIG. 4A is a conceptual diagram showing a finite state machine to track penalties associated with words chosen for the summary, according to embodiments of the present disclosure.

FIGS. 4B-4G show how an example summary may be generated from an example input text using embodiments of the present disclosure.

FIGS. 5A-5C are conceptual diagrams showing how the summary generator component may be trained, according to embodiments of the present disclosure.

FIG. 6 is a conceptual diagram of components of a system, according to embodiments of the present disclosure.

FIG. 7 is a conceptual diagram illustrating components that may be included in a device, according to embodiments of the present disclosure.

FIG. 8 is a conceptual diagram showing how a system may determine summarized text data in response to a user input, according to embodiments of the present disclosure.

FIG. 9 is a signal flow diagram illustrating how a user input may be processed, according to embodiments of the present disclosure

FIG. 10 is a block diagram conceptually illustrating example components of a device, according to embodiments of the present disclosure.

FIG. 11 is a block diagram conceptually illustrating example components of a system, according to embodiments of the present disclosure.

FIG. 12 illustrates an example of a computer network for use with the overall system, according to embodiments of the present disclosure.

### DETAILED DESCRIPTION

Automatic speech recognition (ASR) is a field of computer science, artificial intelligence, and linguistics concerned with transforming audio data associated with speech into a token(s) or other textual representation of that speech. Natural language understanding (NLU) is a field of computer science, artificial intelligence, and linguistics concerned with enabling computers to derive meaning from natural language user inputs (such as spoken inputs). ASR and NLU are often used together as part of a spoken language understanding (SLU) processing component of a system. Text-to-speech (TTS) is a field of computer science, artificial intelligence, and linguistics concerned with transforming text and/or other data into audio data synthesized to resemble human speech.

Certain systems may be configured to perform actions responsive to user inputs. In some cases, the systems may output information that is summarized from one or more source documents. For example, for the user input of “Alexa, what's happening in politics today,” a system may output a summary of current news related to politics. For further example, for the user input of “Alexa, tell me about [celebrity],” the system may output a summary, of information about the celebrity, based on information available on the Internet. In this manner, to respond to user inputs, and for other reasons, the systems may generate summaries for various different topics (e.g., politics, science, economy, technology, health, entertainment, etc.) and entities (e.g., persons, places, things, etc.).

Automatic summarization is the task of generating concise text that expresses the main content of one or more input source documents. Manually written summaries often use original phrases that are not part of the source documents. However, system-generated summaries typically include portions (e.g., phrases, sentences, etc.) copied from the source documents, and include few original words. The present disclosure describes techniques using machine learning models to generate summaries that have more original words and less copied words from the source documents.

In some embodiments, the system of the present disclosure controls a level of originality in the generated summaries using an N-gram setting. The N-gram setting may indicate a number of consecutive words that are allowed to be copied from the source documents. Based on the value of the N-gram setting, the system can limit the length of phrases that are permitted to be copied (verbatim) from the source document(s). The system, instead of copying long phrases, may choose words from a generic vocabulary to convey the content of the source document(s), or may choose words from another part of the source document(s), so that consecutive words are not copied.

In some embodiments, the system may generate different summaries based on the same set of source documents, where the summaries may be based on varying levels of originality. The system may select one of the summaries to present to a user based on the user input and/or context in which the summary is being presented.

The techniques of the present disclosure may provide an improved user experience by providing more natural and original summaries, of text-based documents, for output in response to user input. The techniques of the present disclosure, for example, enable control of how original a generated summary is.

A system according to the present disclosure may be configured to incorporate user permissions and may only perform activities disclosed herein if approved by a user. As such, the systems, devices, components, and techniques described herein would be typically configured to restrict processing where appropriate and only process user data in a manner that ensures compliance with all appropriate laws, regulations, standards, and the like. The systems, devices, components, and techniques can be implemented on a geographic basis to ensure compliance with laws in various jurisdictions and entities in which the components of the systems, devices, components, and/or user are located.

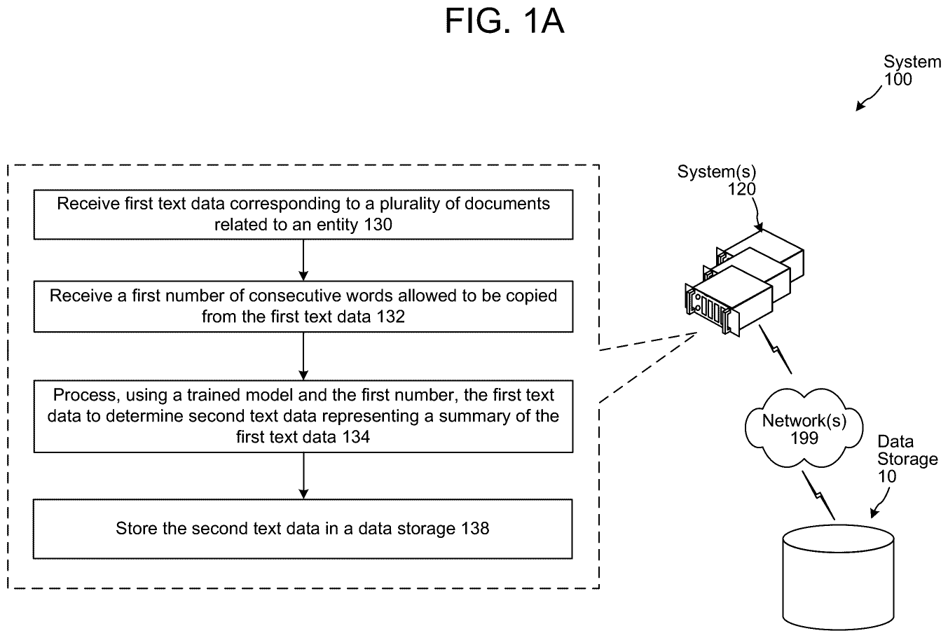

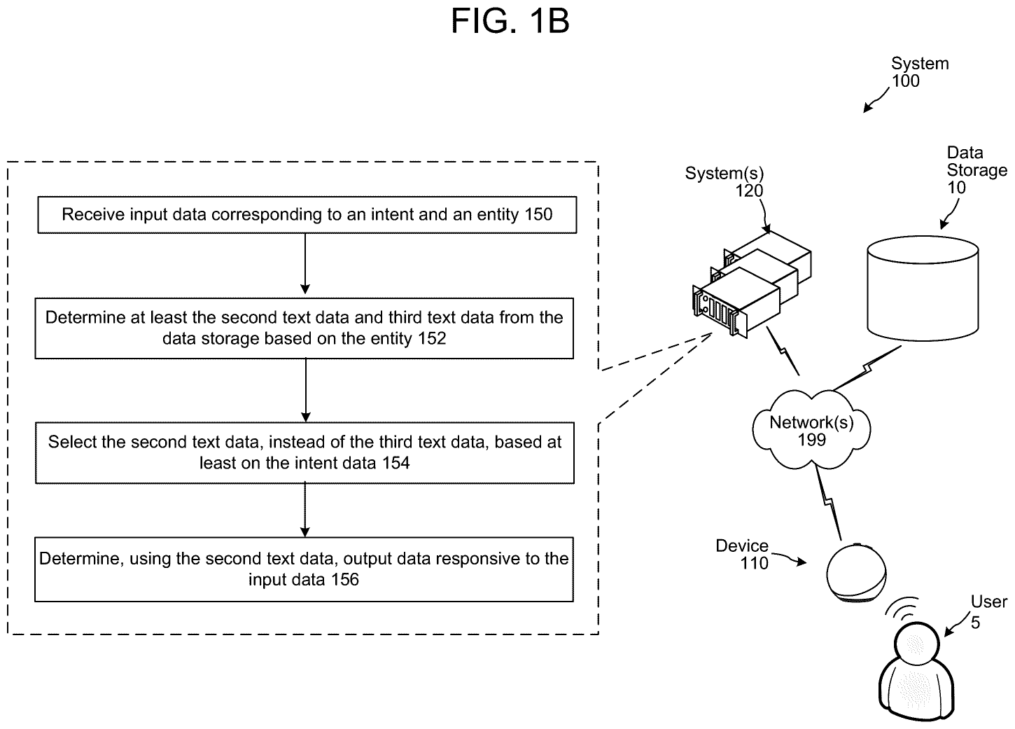

FIG. 1A is a conceptual diagram illustrating a system 100 configured to generate summarized text data by processing multiple input text data, according to embodiments of the present disclosure. FIG. 1B is a conceptual diagram illustrating a system configured to respond to a user input using summarized text data, according to embodiments of the present disclosure. Although the figures and discussion of the present disclosure illustrate certain steps in a particular order, the steps described may be performed in a different order (as well as certain steps removed or added) without departing from the present disclosure. As shown in FIGS. 1A-1B, the system 100 may include a device 110 (local to a user 5), a system(s) 120 and a data storage 10, each in communication across a network(s) 199. The network(s) 199 may include a local-area network(s) (LAN(s)), a wireless local-area network(s) (WLAN(s)), a Metropolitan Area Network(s), a Wide Area Network(s), a Campus Area Network(s), a mobile carrier system(s), and/or the like.

As used herein, processing “text data” of one or more source documents and generating “text data” representing a summary, may include processing tokens corresponding to the words in the source documents, and generating tokens corresponding to the words to be included in the summary,

Referring to FIG. 1A, the system(s) 120 receives (130) first text data corresponding to a plurality of documents related to an entity. Examples of entities include topics, persons, places, and things. Examples of topics may be politics, science, economy, technology, health, entertainment, etc. Examples of persons may be actors, celebrities, politicians, etc. Examples of places may be cities, states, countries, landmarks, buildings, etc. Examples of things may be products, movies, TV shows, companies, etc. The documents may be articles, blog posts, websites, product reviews, etc. related to a particular entity.

The system(s) 120 receives (132) a first number of consecutive words allowed to be copied from the first text data. In some embodiments, the first number may be used to control a level of originality in generating a summary for the first text data. The first number may be configurable each time the system generates a summary, and an administrator or developer may provide an input setting the first number.

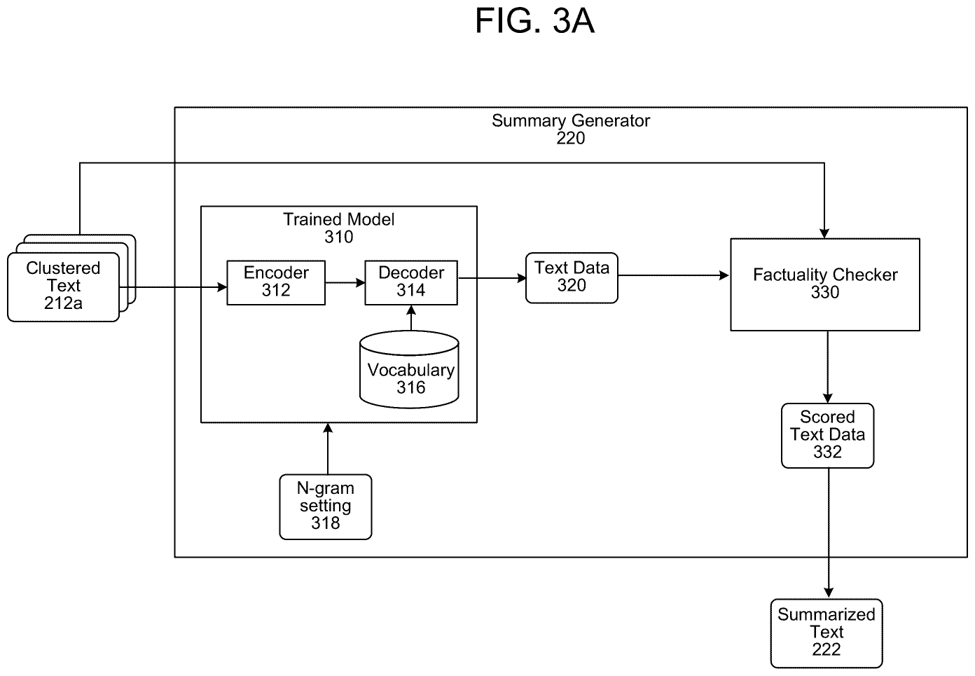

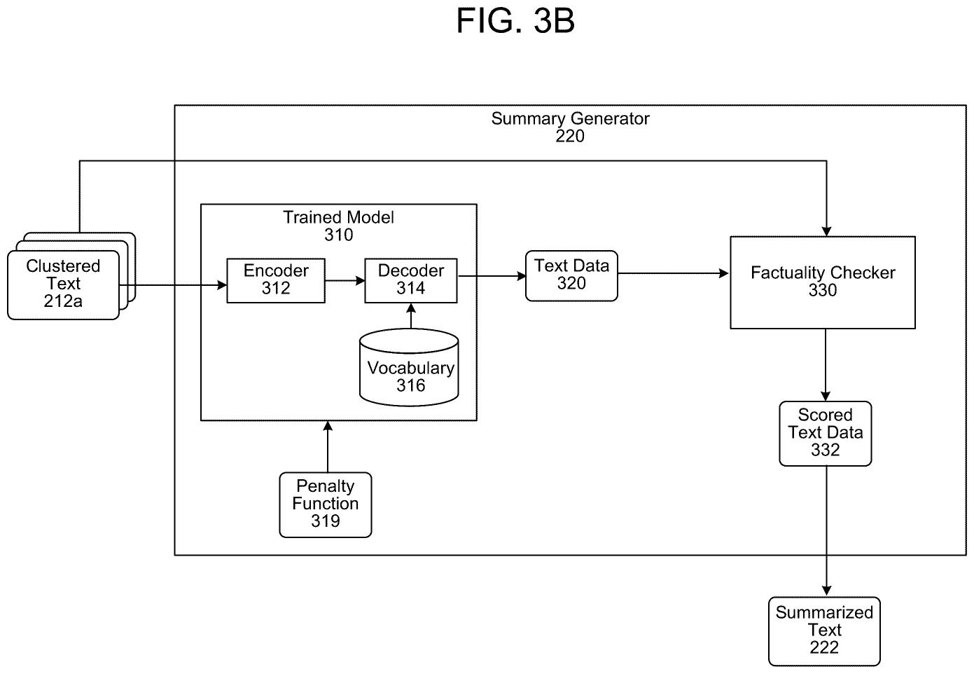

The system(s) 120 processes (134), using a trained model and the first number, the first text data to determine second text data representing a summary of the first text data. The summary may correspond to a particular level of originality. For example, if the first number is a lower number, then the summary may consist of shorter sequences of consecutive words from the source document, as compared to when the first number is a higher number. Details on how the summary may be generated are described in relation to FIGS. 3A and 3B.

The system(s) 120 stores (138) the second text data in the data storage 10. The data storage 10 may store multiple text data representing summaries for different entities. The summaries may correspond to varying levels of originality, as controlled by the number of consecutive words allowed to be copied from the source documents.

Referring to FIG. 1B, the system(s) 120 receives (150) input data corresponding to an intent and an entity. In some embodiments, the input data may be audio data representing a natural language input spoken by the user 5 and captured by the device 110. The device 110 may send the audio data to the system(s) 120 for processing. In some embodiments, the input data may be text data representing a typed natural language input or image data representing a gesture performed by the user 5. The intent, corresponding to the input data, may be a request for information relating to the entity.

The system(s) 120 determines (152) the second text data and third text data from the data storage 10 based on the entity corresponding to the input data. The data storage 10 may store multiple summaries for various different entities. The system(s) 120 may perform a search, using the entity from the input data as the keyword, of the data storage 10. The search results may include one or more summaries containing the keyword/entity, and may be, for example, the second text data and the third text data. The second text data and the third text data, respectively, may represent a first summary and a second summary related to the entity.

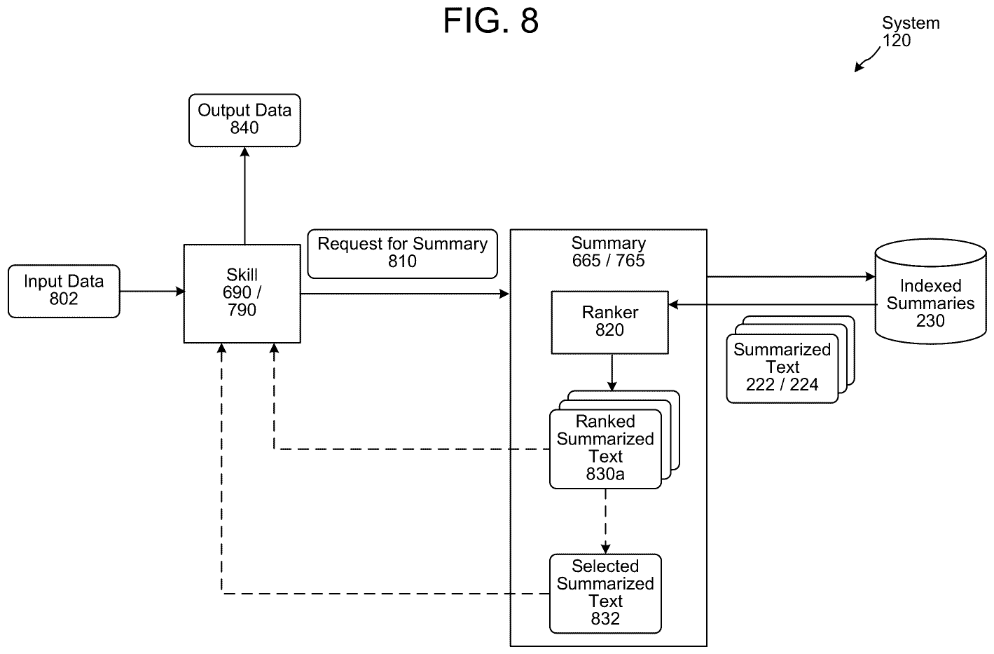

The system(s) 120 selects (154) the second text data, instead of the third text data, based at least on the intent corresponding to the input data. The system(s) 120 may determine that the first summary represented in the second text data is more responsive to the input data/intent than the second summary represented in the third text data. The system(s) 120 may use other factors in selecting the second text data, as described below in relation to FIG. 8. These factors may include a length of the summary, an originality level of the summary, a factuality consistency with respect to the source documents, etc.

The system(s) 120 determines (156), using the second text data, output data responsive to the input data. For example, the system(s) 120 may determine synthesized speech using the second text data, and may output the synthesized speech, providing the first summary as an output to the user 5. In another example, the system(s) 120 may display the second text data at the device 110 to provide the first summary as an output to the user 5. In a further example, the system(s) 120 may output the synthesized speech and display the second text data.

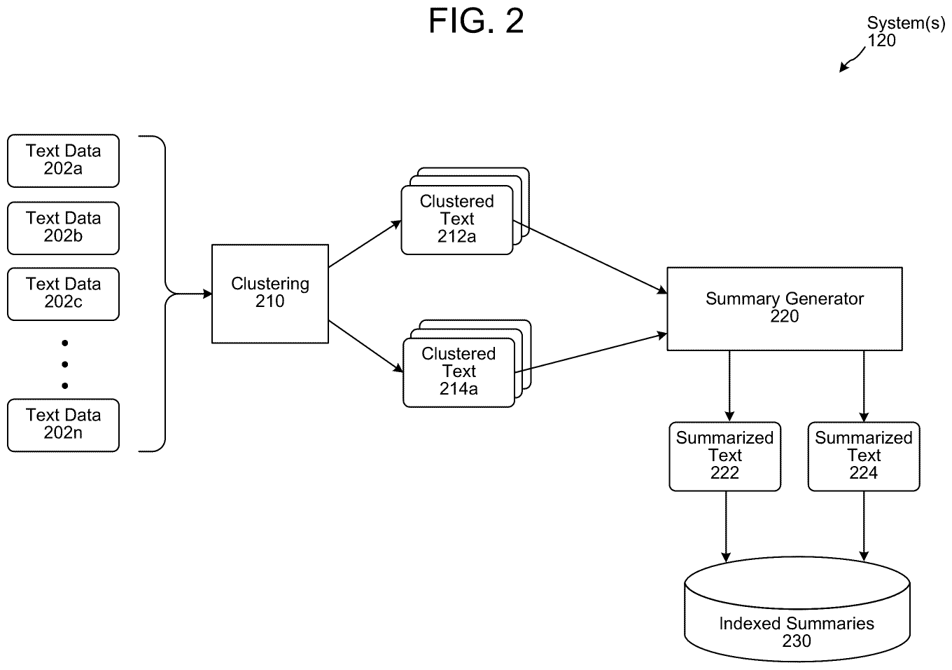

FIG. 2 is a conceptual diagram showing how the system 120 may process multiple text data to generate summarized text data, according to embodiments of the present disclosure. In some embodiments, the system 120 may include a clustering component 210 and a summary generator component 220.

The clustering component 210 may be configured to process multiple different instances of text data, for example, text data 202a-202n. Each instance of the text data 202 may include multiple words in a particular natural language (e.g., English, Spanish, Hindi, etc.). The words may be arranged in sentences, paragraphs, sections, etc. In some embodiments, the text data 202a may be referred to as a document corresponding to one or more particular entities. In some embodiments, each of the text data 202a-202n may be a separate (and different) document, they may relate to multiple different entities, and they may be from multiple different sources (e.g., different websites, different news sources, different blogs, etc.). In an example embodiment, the text data 202 may be a news article, a magazine article, a blog entry, a website article, etc. that may be publicly available on the Internet. In some embodiments, the text data 202 may relate to one or more currently trending entities, and may correspond to the current news and happenings worldwide. In some embodiments, a component (not shown here) may search the Internet for the text data 202. In its search, the component may search for trending entities and/or may search for information (e.g., articles, blogs, etc.) that is published within a specified time period (e.g., within the last 24 hours, within the last 3 days, within the last week, etc.). Based on the search, the component may determine the text data 202. For example, the text data 202a may be a news article corresponding to a first entity published by a first news source, the text data 202b may be a news article corresponding to the first entity published by a second news source, the text data 202c may be blog entry corresponding to a second entity published by a first website, and the text data 202n may be a magazine article corresponding to the second entity published by a second website. Thus, the text data 202 may correspond to multiple different entities and may be from multiple different sources.

Example entities may include, but are not limited to, politics, science, economy, technology, health, entertainment, products, music artists, actors, politicians, celebrities, companies, organizations, landmarks, cities, countries, and the like.

The clustering component 210 may process the multiple different text data 202 to group the multiple different text data 202 based on one or more entities corresponding to the text data 202. To process the text data, the clustering component 210 may employ one or more clustering techniques/algorithms, such as, hierarchical clustering, flat clustering, k-means clustering, Brown clustering, mean-shift clustering, density-based clustering, expectation-maximization clustering, etc. The clustering component 210 may also employ one or more techniques/algorithms to identify the entity corresponding to the text data 202, for example, semantic analysis models, a probabilistic latent semantic analysis, latent Dirichlet allocation, singular value decomposition (SVD), Stochastic block model, etc.

The clustering component 210 may output clustered text data, for example, clustered text data 212 and clustered text data 214, where each clustered text data may correspond to a single entity. Each of the clustered text data 212, 214 may include multiple separate text data corresponding to the single entity. For example, the clustered text data 212 may correspond to the first entity, and the clustered text data 212 may include: clustered text data 212a that corresponds to the text data 202a; clustered text data 212b that corresponds to the text data 202b; and so on. In another example, the clustered text data 214 may correspond to the second entity, and the clustered text data 214 may include: clustered text data 214a that corresponds to the text data 202c; clustered text data 214b that corresponds to the text data 202n. In some embodiments, the clustering component 210 may be configured to perform hard clustering, where a single instance of the text data (e.g., 202a, 202b, 202c, or 202n) may only belong to one single cluster/group corresponding to a single entity and/or entity. In other embodiments, the clustering component 210 may be configured to perform soft clustering, where a single instance of the text data (e.g., 202a, 202b, 202c, or 202n) may belong to one or more clusters/groups. In some embodiments, each of the clustered text data 212, 214 may be associated with an entity indicator based on the entity corresponding to the respective clustered text data. The entity indicator may be text data (or other type of data) identifying the corresponding entity.

It should be understood that more or less instances, than shown in FIG. 2, of the text data 202 may be processed by the clustering component 210, and more or less instances, than shown in FIG. 2, of the clustered text data may be outputted by the clustering component 210.

The summary generator component 220 may process a cluster/group of text data corresponding to a particular entity to generate one or more corresponding summaries. For example, the summary generator component 220 may process the clustered text data 212 to generate one or more summarized text data 222. After processing the clustered text data 212 or in parallel of processing the clustered text data 212, the summary generator component 220 may process the clustered text data 214 to generate one or more summarized text data 224. Details of the summary generator component 220 are described in relation to FIGS. 3A and 3B. In some embodiments, the summary generator component 220 may process the clustered text data 212 and generate multiple different summaries of the clustered text data 212, where the different summaries may include different words, different number of words, different sentence structure, different way of organizing the words, etc. Each of the summarized text data 222, 224 may be associated with the entity indicator associated with the corresponding clustered text data.

The summarized text data 222, 224 may be stored in an indexed summaries storage 230. The indexed summaries storage 230 may store multiple summaries relating to multiple different entities in an indexed manner, so that one or more summaries based on an entity can be easily retrieved. Based on system configuration, the indexed summaries storage 230 may employ a particular data structure to store the summarized text data 222, 224. As described below, the stored summarized text data may be retrieved from the indexed summaries storage 230 to determine output data responsive to a user input.

FIGS. 3A and 3B are conceptual diagrams showing how the summary generator component 220 may generate the summarized text data 222, according to embodiments of the present disclosure. The summary generator component 220 of FIG. 3A may generate summaries based on a predefined N-gram setting. The summary generator component 220 of FIG. 3B may generate summaries based on a non-linear penalizing system.

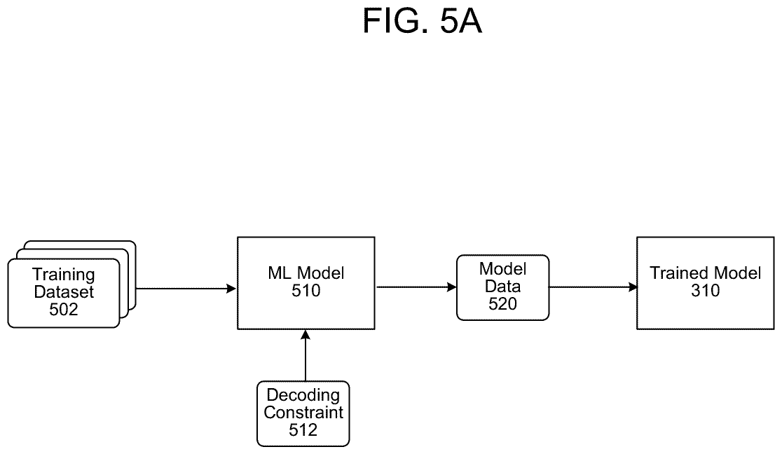

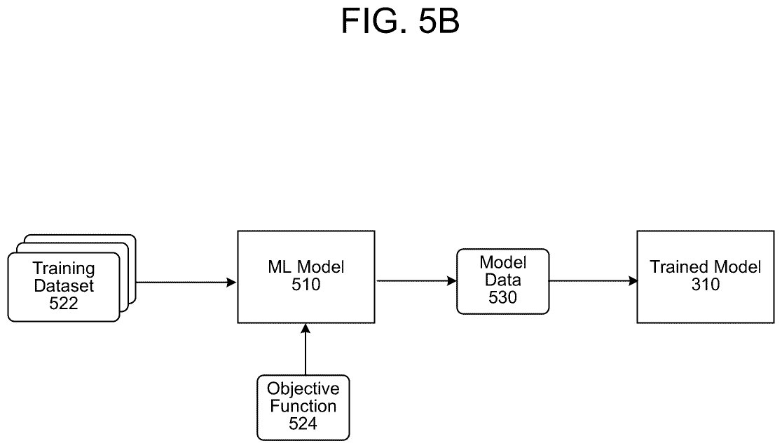

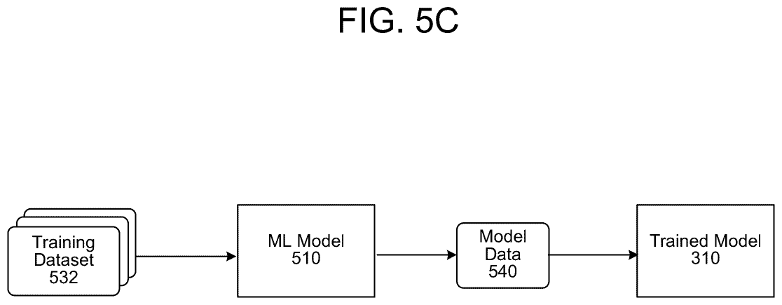

In some embodiments, the summary generator component 220 may employ one or more machine learning models (e.g., a trained model 310) to process text data corresponding to multiple different documents, for example, the clustered text data 212. In some embodiments, the summary generator component 220 may process text data corresponding to a single document, and generate summarized text data representing one or more summaries of the single document. Details on how the trained model 310 is configured/trained are described in relation to FIGS. 5A-5C below.

In some embodiments, the trained model 310 may employ an architecture consisting of an encoder 312 and a decoder 314. The encoder 312 may be configured to understand the words, the context of the words, the semantic meaning of the words, etc. represented in the clustered text data 212. In an example embodiment, the encoder 312 may be a bidirectional transformer (e.g., BERT or RoBERTa). In some embodiments, the encoder 312 may employ hierarchical based encoding, graph based encoding, separate encoding, flat encoding, or other techniques.

The decoder 314 may be configured to generate tokens corresponding to the words to be included in the summary, based on the encoder's 312 understanding of the clustered text data 212. In an example embodiment, the decoder 314 may be a left-to-right transformer (e.g., GPT-2). The decoder 314 may determine to select words from two sources: one being from the clustered text data 212 (the documents the summary generator component 220 is summarizing) and the other from a vocabulary storage 316. The vocabulary storage 316 may store a plurality of generic words (not specific to the source documents, e.g., the clustered text data 212) in a particular natural language (e.g., English) depending on system configuration. The words in the vocabulary storage 316 may be like a dictionary or a thesaurus, from which the decoder 314 may select semantically similar words to the words in the clustered text data 212 to include in the summary.

The decoder 314 may output text data 320 In some embodiments, the decoder 314 may determine one or more different summaries from the clustered text data 212. The different summaries may vary in terms of words used, the number of words (length of summary), sentence structure used in the summary, how the summary is organized, and other features.

In some embodiments, the trained model 310 may be configured to generate summaries with varying levels of originality. As used herein, originality, with respect to a summary, refers to a metric corresponding to the number of words in the summary that are copied from the source documents as compared to the number of words generated/originated (e.g., original words) by the trained model 310. In some embodiments, the original words in the summary may be generated by the trained model 310 using the vocabulary storage 316.

Referring to FIG. 3A, in some embodiments, the originality of the summary may be controlled using an N-gram setting 318 that may be provided to the trained model 310. A value for the N-gram setting 318 may indicate a number of consecutive words that can be copied from the source documents/text data 212 to generate the summary text data 320. The value of the N-gram setting may be set manually by an administrator or developer, and may be changed for each instance of processing source documents. After the number of allowed consecutive words is copied from the source document, the trained model 310 either copies words from another part of the source document or generates an original word from the vocabulary storage 316 that may be semantically similar to the word(s) in the source document.

A smaller value for the N-gram setting 318 may result in a summary with more original content and fewer copied phrases, as compared to a summary that is generated using a larger value for the N-gram setting 318. For example, if the N-gram setting 318 is “3” then the trained model 310 copies only three consecutive words from the source document (in any given instance, as the resulting summary may include more than one instance of three consecutive words being copied from the source document). For further illustration, consider a source document/text data 212 including the following sentences: “The census bureau reported that 16 million children in 2014 in the country received food stamps, or about one in every five kids. Census said that that number is up dramatically from 2007, before the great recession, when 9 million kids were receiving food stamps, or about one in eight.” With the N-gram setting 318 at “3”, the trained model 310 may generate a summary/text data 320 that may include the following sentence: “In 2014, 16 million children in the country were using food stamps, as compared to 9 million kids in 2007.” Thus, the trained model 310, in this example, copied the phrase “in 2014,” “16 million children”, “food stamps,” and “9 million kids.” After copying the third word, such as in “16 million children”, the trained model 310 copied the words “in the country” from a different part of the source document. After copying the words “food stamps” the trained model 310 generated the original words “as compared to.”

For an illustrative comparison, consider the same example source document, with the N-gram setting 318 set to “6.” In this case, the trained model 310 may generate a summary/text data 320 that may include the following sentence: “16 million children living in America were using food stamps in 2014, that number is up dramatically from 2007. In 2007, before the great recession, 9 million kids were receiving food stamps.” Thus, the trained model 310 copied the six consecutive words “16 million children living in America” and then generated the original words “were using.” In this manner, the N-gram setting 318 may be used to control the originality of the summary generated by the trained model 310 from the source documents/text data 212

In some embodiments, the trained model 310 may interpret the N-gram setting 318 as a strict/hard setting based on system configurations, where the trained model 310 may copy the exact number of words indicated in the N-gram setting 318 and then only copy from elsewhere in the source document or generate original words (e.g., copy six words then copy six words from elsewhere in the source document or generate an original word). In other embodiments, the trained model 310 may interpret the N-gram setting 318 as a soft setting based on system configurations, where the trained model 310 may not copy more than the numbers indicated in the N-gram setting 318 (e.g., copy no more than six words then copy no more than six words from elsewhere or generate an original word).

In some embodiments, the N-gram setting 318 may be a vector of values, for example, {3, 5, 6, 10}, and the trained model 310 may generate different summaries using the different N-gram setting values in the vector. For example, the text data 320a may be generated using the N-gram value “3”, the text data 320b may be generated using the N-gram value “5”, text data 320c may be generated using the N-gram value “6”, and the text data 320n may be generated using the N-gram value “10.” In this manner, the trained model 310 may generate different summaries, for the same source documents, with varying levels of originality.

Referring to FIG. 3B, in some embodiments, the originality of the summary may be controlled using a penalty function 319. This technique involves the sequence-to-sequence models (e.g., the encoder 312 and the decoder 314) and involves penalizing longer sequences of consecutive words copied from the source document more than multiple shorter sequences of consecutive words copied from the source document that may add up to the same length as the longer sequences. The penalty function 319 may be a non-linear function that increases the penalty as the number of the copied consecutive words in a sequence increases. For example, the penalty for copying six consecutive words from the source document may be exponentially higher than the penalty for copying three consecutive words. The penalty function 319 may change the probability of selecting a word, for the summary, by the decoder 314 based on the prior word selected by the decoder 314 for the summary. In this embodiment, the penalty function 319 may be used with the trained model 310 or with any other trained models configured to generate summaries to control a level of originality for the summary.

The penalty function 319 may be determined as follows to control the level of originality of a summary y (e.g., text data 320) obtained by decoding input x (e.g., text data 212). For example, [symbol] (x, y) may be the set of the longest sequence of consecutive words in y with respect to x. The penalty function 319 may be defined as λₕ(|f|) that may be a penalty term for copied consecutive words. The penalty function 319 may assign a discount probability to any sequence of consecutive words f∈ [symbol] (x, y) that grows nonlinearly with its number of words/tokens, penalizing longer sequences of consecutive words more strongly than multiple shorter sequences with the same combined length:

$${λ}_{h} ( \vert f \vert ) = {2}^{- {\vert f \vert}^{2} / {h}^{2}} \qquad Equation ( 1 )$$

Equation (1) may be configured with a parameter h, representing a number of consecutive words allowed to be copied from the input text, for which λₕ=0.5, for example. Setting h to smaller values may result in summaries that are more original, since shorter sequences of consecutive words will be penalized more strongly by λₕ, as compared to when h is set to larger values. Additionally, the values for |f|² and h² may be configured. A larger value for these exponents may result in a steeper descent around h.

During decoding, the decoder 314 may search for the summary y that maximizes the product of the summarization model probability ρM(y|x), and the discount probabilities of the sequence of consecutive words [symbol] (x, y):

$$\hat{y} = arg {max}_{y} ρ M ( y \vert x ) \times {\prod }_{f ∈ ℱ ( x , y )} {λ}_{h} ( \vert f \vert ) \qquad Equation ( 2 )$$

The model probability ρM(y|x) in neural text generation models may decompose naturally for token-by-token decoding as Πₜ₌₁^{|y|}ρM(yᵢ|x, yᵢ, . . . , yₜ₋₁). Similarly, the application of the λₕ function is decomposed for any partial or completed sequence of consecutive words f:

$${λ}_{h} ( \vert f \vert ) = {\prod }_{l = 1}^{\vert f \vert} \frac{{λ}_{h} ( l )}{{λ}_{h} ( l - 1 )} \qquad Equation ( 3 )$$

The decoder 314 may successively apply λₕ at each output position i in beam decoding, where each candidate for token yₜ is evaluated to check whether choosing it would extend a sequence of consecutive words to length l. If so, its model probability pM(yₜ| . . . ) is multiplied with λₕ(l), and the λₕ(l−1) that was applied to the previous token yₜ₋₁ is divided out.

The decoder 314 may search for ŷ in log space using log probabilities and the log of λₕ defined in Equation (1). It can be shown that

$$log {λ}_{h} ( \vert f \vert ) = \frac{- {\vert f \vert}^{2}}{{( 1.20112 \times h )}^{2}} \qquad Equation ( 4 )$$

In some embodiments, the summary generator component 220 can be configured to generate less original summaries, by employing a rewards function instead of a penalty function. In this case, the Equation (1) may involve the inverse 1/λₕ, such that smaller h values may result in summaries that are less original than when h is set at larger values.

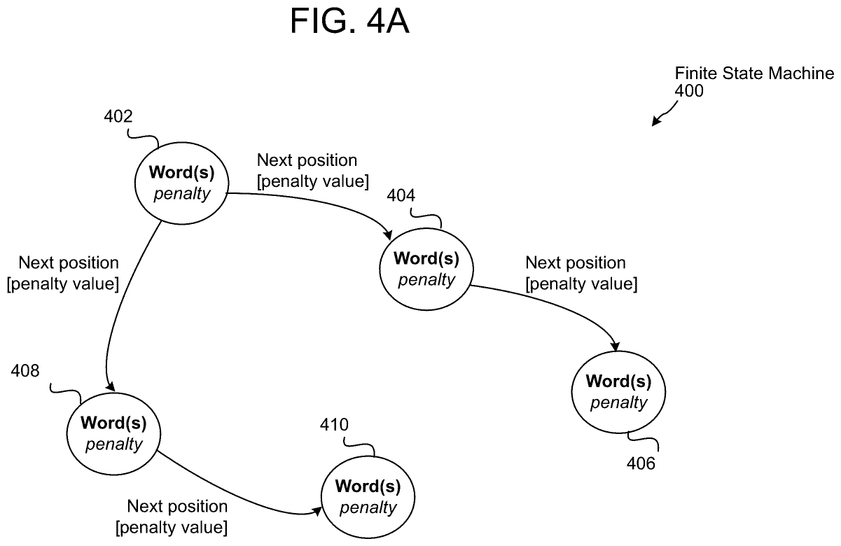

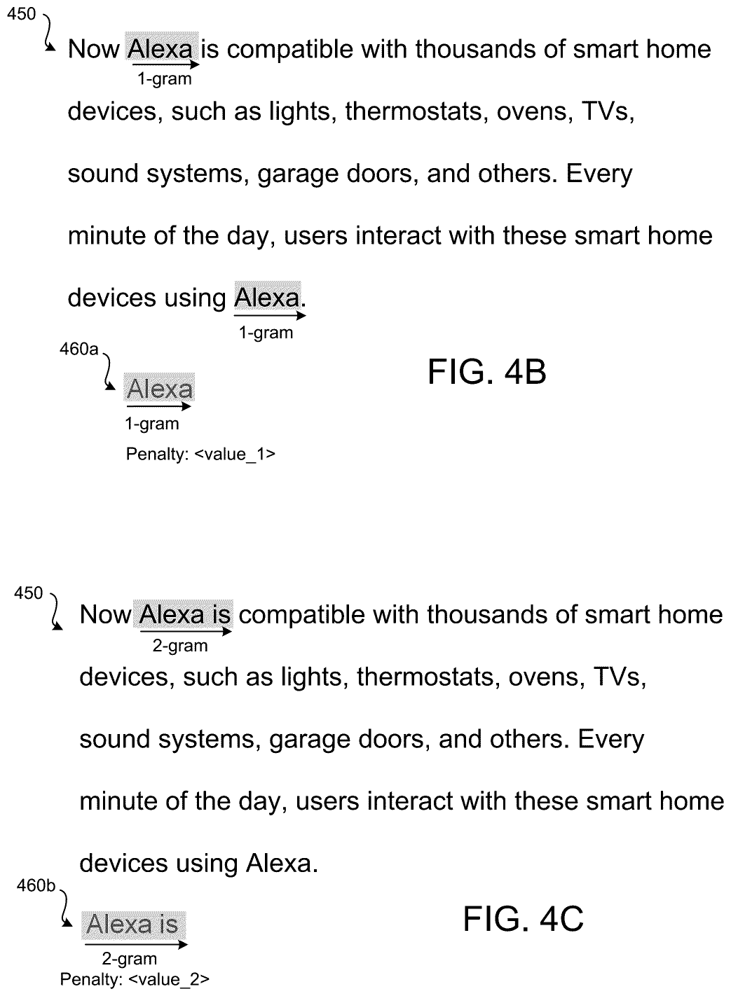

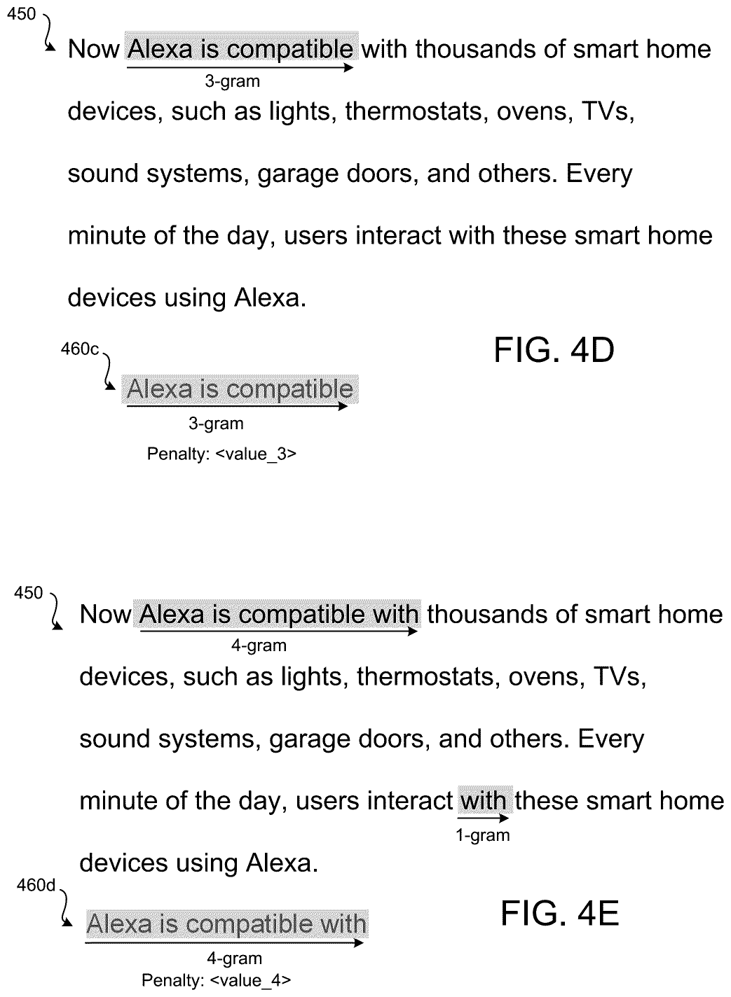

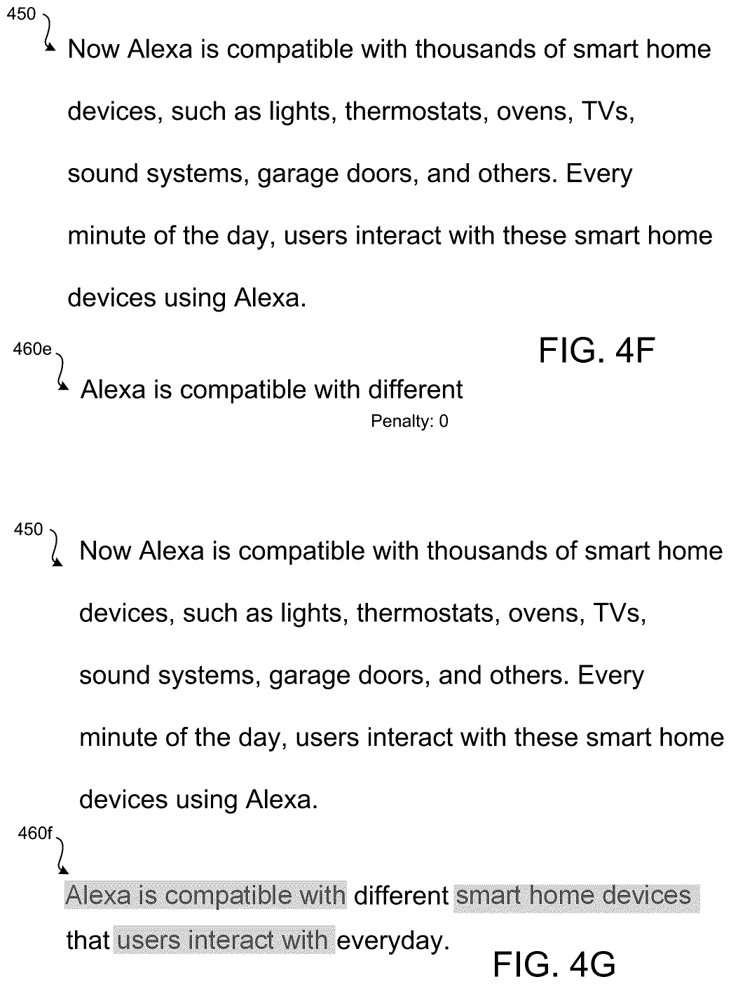

In some embodiments, the summary generator component 220 may include a finite-state machine that encodes weighted decoding constraints as the decoder 314 determines the text data 320 for the summary on a word-by-word basis. FIG. 4A shows state data for an example finite state machine 400. The finite-state machine may include data indicating a penalty value along with each N-gram corresponding to a set of consecutive words (e.g., phrases) from the source documents (e.g., the clustered text data 212) that the summary generator component 220 is to not use in the generated summary. For example, the data in the finite-state machine may be all N-grams of length 3 or higher. As shown in FIG. 4A, each of a state 402, 404, 406, 408 and 410 may be associated with one or more words and a respective penalty. The penalty value may be based on the length of the N-gram, for example, longer N-grams may be penalized more than shorter N-grams. In some embodiments, individual N-grams/words may also be associated with a penalty, based on system configuration. In this manner, penalty information for particular words and phrases may be stored in the finite-state machine for the decoding process to generate the summary. Using such a finite-state machine to store the penalty information, penalties for particular words and phrases, in the source documents, can be removed or set to 0. For example, if the source documents relate to a particular entity (e.g., House of Representatives), then the N-grams representing “House of Representatives” may not be included in the finite-state machine, or may be associated with zero penalty, so that the trained model 310 includes the words “House of Representatives” in the generated summary/text data 320. In some embodiments, the finite-state machine may include fallback arcs, which represent other N-grams/words/phrases that have no penalties.

In some embodiments, with each word generated by the decoder 314, the summary generator component 220 may track the state in the finite-state machine. When the decoder 314 scores a set of candidate words to output at the current position (in the summary), the scores may be multiplied by any penalties accumulated at the current state (based on the words outputted so far in the summary) in the finite-state machine. When the decoder 314 selects a particular word, for example, the word(s) in the state 402, the summary generator component 220 may follow the corresponding arc in the finite-state machine, leading to the next state, either state 404 or state 408. The accumulated penalty is passed on to the next state, as shown in FIG. 4A. This process continues at the next position that the decoder 314 selects a word for in the summary.

FIGS. 4B-4G show another example summary generated using the techniques described above. Input text 450 may be an example of a paragraph included in the clustered text data 212a (shown in FIGS. 3A and 3B). Text 460 may be an example of a summary represented in the text data 320. The example summary, shown in FIGS. 4B-4G, may be generated using the system of FIG. 3A or 3B. The text 460a illustrates a first word “Alexa” selected by the decoder 314 for the summary. The summary generator component 220 may keep track of the two possible positions, within the input text 450, that the first word may be copied from, and may determine an n-gram counter, for example 1-gram, to track the number of consecutive words copied. The tracking of the copied word may be case-insensitive. Additionally, the summary generator component 220 may determine a penalty as value_1 associated with copying that word. The penalty may be based on the number of consecutive words copied, in this case, 1-gram.

The text 460b, shown in FIG. 4C, illustrates the decoder 314 selecting a second word “is” for the summary. The summary generator component 202 may keep track of where the two consecutive words “Alexa is” is copied from the input text 450 as shown by the highlighted text. The summary generator component 220 may also determine the n-gram counter to be 2-gram, and may determine the penalty as value_2, where the value_2 may be based on selection of two consecutive words from the input text 450. In some cases, the penalty value_2 may be higher than the penalty value_1. The penalty may be increased in a non-linear manner (e.g., exponentially increased). In some embodiments, the penalty may be increased in a linear manner. Based on the penalty value, the decoder 314 may select the next word in the summary.

In some embodiments, there may be a discount probability associated with the copied word, such that the probability of the decoder 314 selecting the word right after is reduced by the discount probability. For example, the word “Alexa” may be associated with a first probability value (e.g., value_1 since it is the first word selected for the summary), and the word “is” may be associated with a second probability value. After the decoder 314 selected the word “Alexa” (as shown in FIG. 4B), the probability of the word “is” may be {the second probability value—the value_1} or {the second probability×value_1). Thus, the probability of the word “is” may be reduced/updated, thus, reducing the probability of the decoder 314 selecting the word “is” next.

The text 460c, shown in FIG. 4D, illustrates the decoder 314 selecting a third word “compatible” for the summary. The summary generator component 220 may also keep track of the n-gram counter as 3-gram indicating that three consecutive words have been copied from the input text 450 for the text 460c, and may also determine the penalty as value_3. The text 460d, shown in FIG. 4E, illustrates the decoder 314 selecting a fourth word “with” for the summary. In this case, the summary generator component 220 may track the four consecutive words “Alexa is compatible with” in the input text 450 as shown by the highlighted text in FIG. 4E, and may determine the n-gram counter as 4-gram based on the two consecutive words “zoo is” from the input text 450. The penalty may be value_4, which may be higher than the value_3.

The text 460e, shown in FIG. 4F, illustrates the decoder 314 selecting a fourth word “different” from the vocabulary storage 316, and not from the input text 450. The penalty associated with an original word may be zero. Selection of the original word may also reset the penalty value to zero and may reset the n-gram counter to zero, since the penalty and n-gram counter are used to track consecutive words copied from the input text 450.

The above example process may continue, where the decoder 314 sequentially selects words for the summary, either by copying from the input text 450 or selecting an original word from the vocabulary storage 316, and the summary generator component 220 keeps track of the consecutive words copied from the input text 450 and the penalty for copying consecutive words from the input text 450. As the penalty increases, the decoder 314 may select from another part of the input text 450, to reduce or reset the penalty, or may select an original word from the vocabulary storage 316. The summary text 460f of FIG. 4G shows an example summary for the text 450 generated at the end of the process. The n-grams copied from the text 450 are highlighted for illustration.

Prior to determining to store the generated summaries/text data 320, the summary generator component 220 may use a factuality checker component 330. The factuality checker component 330 may employ one or more machine learning models, for example, a logistic regression model, a neural network, or other types of models. The factuality checker component 330 may be configured to compare the source documents, for example, the clustered text data 212 and the corresponding generated summary, for example, the text data 320, to determine whether the generated summary is an accurate representation (e.g., factually consistent) of the information in the source documents. The factuality checker component 330 may take as input the clustered text data 212 and the generated text data 320, and may output data representing a score corresponding to each of the generated text data 320. In some embodiments, the factuality checker component 330 may consider a number of words in the summary that were copied from the source document, a number of consecutive words copied from the source document, a number of entities (e.g., named person(s), named location(s), named thing(s), etc.) that were copied from the source documents, and additional factors, in generating the score. The score, generated by the factuality checker component 330, may be a likelihood of how factually consistent the summary is as compared to the source document. The factuality checker component 330 may generate scored text data 332, where the text data 320 may be associated with its corresponding generated score.

In some embodiments, the factuality checker component 330 may determine one or more metrics to determine the score. The metrics may be determined using question-answering techniques. One of the question-answering techniques may involve converting the source document text/the clustered text data 212 into Cloze-style questions by masking the entities in the text. The masked source text data may be processed using a BERT model that attempts to recover the masked entities based on the generated summary text data 320. An entity matching metric (e.g., a matching score) may be generated based on the number of entities and the accuracy of the entities determined by the BERT model. The entity matching metric may be used to determine the scored text data 332.

One of the other metrics used by the factuality checker component 330 may involve measuring how well questions can be answered using the generated summary. For example, the factuality checker component 330 may generate a question from masked summary text data 320, where an entity, in the text data 320, is masked and is the answer to the question. Using a question model (e.g., a ML model) on the source document/clustered text data 212, the masked entity, which the answer, is compared to the answer generated by the question model from the source document. A metric comparing the answers to the question may be used to generate the scored text data 332.

Another technique may involve a question generation model that may generate questions from the summary text data 320. A question answer model may generate answers to these questions from both of the summary text data 320 and the source document/clustered text data 212. A metric based on the similarity of the answers generated from the summary and the source document for the respective questions may be determined, and used to determine to the scored text data 332.

In another technique, the factuality checker component 330 may use a BERT-based binary classifier, which may be trained on weakly-supervised sentence pairs, to determine a score at a sentence-level (e.g., a score for each sentence in the summary text data 320) based on the sentences in the source document/clustered text data 212. A mean of the scores for the sentences in the summary text data 320 may be used as the score generated by the factuality checker component 330.

In some embodiments, the factuality checker component 330 may generate the scored text data 332 based on a level of originality of the summary text data 320. The score may be based on measuring the absence of surface-level, lexical overlap between the source document/clustered text data 212 and the summary text data 320. To determine the score, the factuality checker component 330 may determine an n-gram overlap value, which may be a percentage of words in the summary text data 320 that are copied from the source document. The score may additionally or alternatively be based on a longest common subsequence metric, which may represent the ratio of the length of the longest sequence of consecutive words in the summary text data 320 from the source document and the length/number of words in the source document.

In some embodiments, each of the scored text data 332 may be stored as the summarized text data 222 in the indexed summaries storage 230 (shown in FIG. 2). In some embodiments, the summary generator component 220 may select a subset of the scored text data 332, based on the corresponding scores, to store as the summarized text data 222 in the indexed summaries storage 230. For example, the summary generator component 220 may only store the scored text data 332 that have corresponding scores above a threshold score. In another example, the summary generator component 220 may only store a number of top scoring (e.g., the top five scoring) text data 332.

The summary generator component 220 may process the clustered text data 214 shown in FIG. 2 to generate the summarized text data 224 in a similar manner as described above in relation to processing of the clustered text data 212. In some embodiments, the summary generator component 220 may process text data/documents that are not pre-clustered/pre-grouped by the clustering component 210.

FIGS. 5A-5C are conceptual diagrams showing how the trained model 310 of the summary generator component 220 may be trained, according to embodiments of the present disclosure. The summary generator component 220 may be configured/trained at the system(s) 120 or another system(s). In some embodiments, during training operations, the system may provide decoding constraints 512 to the machine learning (ML) model 510, as shown in FIG. 5A. The decoding constraint 512 may be similar to providing the N-gram setting 318 described in relation to FIG. 3A above. The decoding constraint 512 may indicate to the ML model 510 how many consecutive words can be copied from the source documents (e.g., text data from articles, websites, etc.) in the training dataset 502. The training dataset 502 may also include reference summaries corresponding to the source documents. In some embodiments, during training, the system may keep track of the words copied from the training documents, by using a counter for example. After the counter reaches the value indicated in the decoding constraint, the ML model 510 may be forced to choose an original word in generating the summary or select from elsewhere within the training documents. In some embodiments, the system may impose a penalty during the training operations, where the penalty may increase as the number of words (the number of N-grams) copied from the training documents increases, thus, enabling the ML model 510 to learn to copy less consecutive words from the training dataset 502. In some embodiments, use of certain phrases/consecutive words, such as ones that appear in multiple training documents, may not be penalized or may be penalized less. For example, the phrase “received food stamps” may not be penalized or may be penalized less based on it appearing in multiple training documents corresponding to the entity and/or based on the phrase appearing in one training document multiple times. The training dataset 502 may be a group of documents that correspond to the same entity.

In some embodiments, during training operations, the system may employ an objective function 524 that enables the ML model 510 to learn how to generate summaries with a certain level of originality, as shown in FIG. 5B. Each word in a source document in the training dataset 522 may be labeled to indicate (1) that the word is an original enough word that can be copied into the summary or (2) that the word is not original enough and a replacement word should be used in the summary. To adjust the level of originality of the summaries generated by the ML model 510, the objective function 524 may assign a corresponding loss to selection of each word in the summary. For example, if the ML model 510 is to be trained to generate more original summaries, then the words labeled as “original” and selected for the summary may be assigned a lower loss than words labeled as “not original” are selected for the summary. In another example, if the ML model 510 is to be trained to generate less original summaries, then the words labeled as “original” and selected for the summary may be assigned a higher loss than words labeled as “not original.” Thus, the training operations of this system may employ a selective word-based weighting. The probabilities of the words generated by the decoder of the ML model 510 may change during each instance based on the previously selected word.

Referring to FIG. 5C, in some embodiments, the ML model 510 may be trained using a training dataset 532 that includes source documents and corresponding reference summaries, where the reference summaries may have a level of originality that the trained model 310 is to have in generating summaries. The training dataset 532 may include more than one source document (e.g., an article, blog post, etc.) corresponding to a particular entity. The training dataset 532 may be associated with one (or more) reference summary based on the source documents. The reference summary may be generated manually and may include a certain number of consecutive words copied from the source documents, and other words may be original words that semantically represent the information in the source documents. Training using such a training dataset may enable the ML model 510 to learn weights and parameters that result in the ML model 510 generating summaries with a certain level of originality.

The ML model 510 may have an architecture including an encoder and a decoder. The encoder and the decoder may be trained simultaneously using one or more of the techniques described in relation to FIGS. 5A-5C. After the ML model 510 is trained, the resulting model data 520, 530 or 540 (e.g., learned weights, learned parameters, etc.) may be used to generate the trained model 310 shown in FIGS. 3A and 3B.

In some embodiments, the ML model 510 may be pre-trained using a certain training dataset and to generate a summary from source documents. After pre-training, the ML model 510 may be fine-tuned using another certain training dataset to generate a summary of a certain level of originality. As such, the ML model 510 may be pre-trained to generate summaries, and then fine-tuned to generate summaries having a certain level of originality. The ML model 510 may be fine-tuned using one or more of the techniques described in relation to FIGS. 5A-5C.

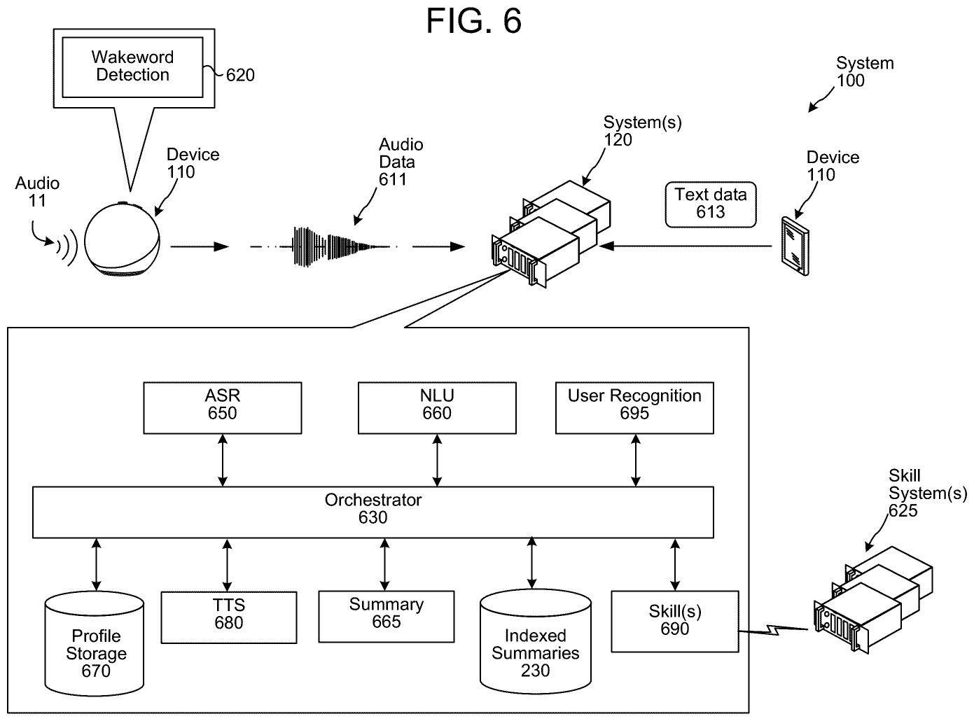

The system 100 may operate using various components as illustrated in FIG. 6. The various components may be located on a same or different physical devices. Communication between various components may occur directly or across a network(s) 199.

A microphone or array of microphones (of or otherwise associated with a device 110) may capture audio 11. The device 110 processes audio data, representing the audio 11, to determine whether speech is detected. The device 110 may use various techniques to determine whether audio data includes speech. In some examples, the device 110 may apply voice activity detection (VAD) techniques. Such techniques may determine whether speech is present in audio data based on various quantitative aspects of the audio data, such as the spectral slope between one or more frames of the audio data, the energy levels of the audio data in one or more spectral bands, the signal-to-noise ratios of the audio data in one or more spectral bands, or other quantitative aspects. In other examples, the device 110 may implement a classifier configured to distinguish speech from background noise. The classifier may be implemented by techniques such as linear classifiers, support vector machines, and decision trees. In still other examples, the device 110 may apply Hidden Markov Model (HMM) or Gaussian Mixture Model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Once speech is detected in audio data representing the audio 11, the device 110 may determine if the speech is directed at the device 110/system 120. In at least some embodiments, such determination may be made using a wakeword detection component 620. The wakeword detection component 620 may be configured to detect various wakewords. In at least some examples, each wakeword may correspond to a name of a different digital assistant. An example wakeword/digital assistant name is “Alexa.”

Wakeword detection is typically performed without performing linguistic analysis, textual analysis, or semantic analysis. Instead, the audio data, representing the audio 11, is analyzed to determine if specific characteristics of the audio data match preconfigured acoustic waveforms, audio signatures, or other data corresponding to a wakeword.

Thus, the wakeword detection component 620 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 620 may be built on deep neural network (DNN)/recursive neural network (RNN) structures directly, without HMM being involved. Such an architecture may estimate the posteriors of wakewords with context data, either by stacking frames within a context window for DNN, or using RNN. Follow-on posterior threshold tuning or smoothing is applied for decision making. Other techniques for wakeword detection, such as those known in the art, may also be used.

Once the wakeword detection component 620 detects a wakeword, the device 110 may “wake” and begin transmitting audio data 611, representing the audio 11, to the system 120. The audio data 611 may include data corresponding to the detected wakeword, or the device 110 may remove the portion of the audio corresponding to the detected wakeword prior to sending the audio data 611 to the system 120.

The system 120 may include an orchestrator component 630 configured to, among other things, coordinate data transmissions between components of the system 120. The orchestrator component 630 may receive the audio data 611 from the device 110, and send the audio data 611 to an ASR component 650.

The ASR component 650 transcribes the audio data 611 into ASR output data including one or more ASR hypotheses. An ASR hypothesis may be configured as a textual interpretation of the speech, or may be configured in another manner, such as one or more tokens. Each ASR hypothesis may represent a different likely interpretation of the speech in the audio data 611. Each ASR hypothesis may be associated with a score representing a confidence of ASR processing performed to determine the ASR hypothesis with which the score is associated.

The ASR component 650 interprets the speech in the audio data 611 based on a similarity between the audio data 611 and pre-established language models. For example, the ASR component 650 may compare the audio data 611 with models for sounds (e.g., subword units, such as phonemes, etc.) and sequences of sounds to identify words that match the sequence of sounds of the speech represented in the audio data 611.

In at least some instances, instead of the device 110 receiving audio 11, the device 110 may receive a text-based (e.g., typed) natural language user input. The device 110 may determine text data 613 representing the typed natural language user input, and may send the text data 613 to the system 120, wherein the text data 613 is received by the orchestrator component 630.

The orchestrator component 630 may send the text data 613 or ASR output data output, depending on the type of natural language user input received, to a NLU component 660. The NLU component 660 processes the ASR output data or text data to determine one or more NLU hypotheses embodied in NLU output data. The NLU component 660 may perform intent classification (IC) processing on the ASR output data or text data to determine an intent of the natural language user input. An intent corresponds to an action to be performed that is responsive to the natural language user input. To perform IC processing, the NLU component 660 may communicate with a database of words linked to intents. For example, a music intent database may link words and phrases such as “quiet,” “volume off,” and “mute” to a <Mute> intent. The NLU component 660 identifies potential intents by comparing words and phrases in ASR output data or text data to the words and phrases in an intents database. In at least some embodiments, the NLU component 660 may communicate with multiple intents databases, with each intents database corresponding to one or more intents associated with a particular skill.

For example, IC processing of the natural language user input “play my workout playlist” may determine an intent of <PlayMusic>. For further example, IC processing of the natural language user input “call mom” may determine an intent of <Call>. In another example, IC processing of the natural language user input “call mom using video” may determine an intent of <VideoCall>. In yet another example, IC processing of the natural language user input “what is today's weather” may determine an intent of <OutputWeather>.

The NLU component 660 may also perform named entity recognition (NER) processing on the ASR output data or text data to determine one or more portions (which may be referred to as one or more slots) of the natural language user input that may be needed for post-NLU processing (e.g., processing performed by a skill). For example, NER processing of the natural language user input “play [song name]” may determine a slot corresponding to “SongName: [song name].” For further example, NER processing of the natural language user input “call mom” may determine a slot corresponding to “Recipient: Mom.” In another example, NER processing of the natural language user input “what is today's weather” may determine a slot corresponding to “Date: Today.”

In at least some embodiments, the intents identifiable by the NLU component 660 may be linked to one or more grammar frameworks with “slots” to be filled. Each slot of a grammar framework corresponds to a portion of ASR output data or text data that the NLU component 660 believes corresponds to an entity. For example, a grammar framework corresponding to a <PlayMusic> intent may correspond to sentence structures such as “Play {Artist Name},” “Play {Album Name},” “Play {Song name},” “Play {Song name} by {Artist Name},” etc.

For example, the NLU component 660 may perform NER processing to identify words in ASR output data or text data as subject, object, verb, preposition, etc. based on grammar rules and/or models. Then, the NLU component 660 may perform IC processing that involves using the identified verb to identify an intent. Thereafter, the NLU component 660 may again perform NER processing to determine a grammar model associated with the identified intent. For example, a grammar model for a <PlayMusic> intent may specify a list of slots applicable to play the identified “object” and any object modifier (e.g., a prepositional phrase), such as {Artist Name}, {Album Name}, {Song name}, etc. The NER processing may then involve searching corresponding fields in a lexicon, attempting to match words and phrases in the ASR output data that NER processing previously tagged as a grammatical object or object modifier with those identified in the lexicon.

NER processing may include semantic tagging, which is the labeling of a word or combination of words according to their type/semantic meaning. NER processing may include parsing ASR output data or text data using heuristic grammar rules, or a model may be constructed using techniques such as hidden Markov models, maximum entropy models, log linear models, conditional random fields (CRF), and the like. For example, NER processing with respect to a music skill may include parsing and tagging ASR output data or text data corresponding to “play mother's little helper by the rolling stones” as {Verb}: “Play,” {Object}: “mother's little helper,” {Object Preposition}: “by,” and {Object Modifier}: “the rolling stones.” The NER processing may identify “Play” as a verb based on a word database associated with the music skill, which IC processing determines corresponds to a <PlayMusic> intent.

The NLU component 660 may generate NLU output data including one or more NLU hypotheses, with each NLU hypothesis including the intent and slot(s) determined from IC processing and NER processing of the ASR output data or text data. In at least some embodiments, the NLU component 660 may perform IC processing and NLU processing with respect to different skills. One skill may support the same or different intents than another skill. Thus, the NLU output data may include multiple NLU hypotheses, with each NLU hypothesis corresponding to IC processing and NER processing performed on the ASR output or text data with respect to a different skill.

As described above, the system 120 may perform speech processing using two different components (e.g., the ASR component 650 and the NLU component 660). In at least some embodiments, the system 120 may implement a spoken language understanding (SLU) component configured to process audio data 611 to determine NLU output data.

The SLU component may be equivalent to a combination of the ASR component 650 and the NLU component 660. Yet, the SLU component may process audio data 611 and directly determine the NLU output data, without an intermediate step of generating ASR output data. As such, the SLU component may take audio data 611 representing speech and attempt to make a semantic interpretation of the speech. That is, the SLU component may determine a meaning associated with the speech and then implement that meaning. For example, the SLU component may interpret audio data 611 representing speech from the user 5 in order to derive a desired action. The SLU component may output a most likely NLU hypothesis, or multiple NLU hypotheses associated with respective confidence or other scores (such as probability scores, etc.).

The NLU component 660 may send the NLU output data to the orchestrator component 630. The orchestrator component 630 may send the top-scoring NLU hypothesis (in the NLU output data) to a skill associated with the NLU hypothesis.

The system 120 may include one or more skill components 690 and/or may communicate with one or more skill systems 625 via one or more skill components 690. As used herein, a “skill” may refer to a skill component 690, a skill system 625, or a combination of a skill component 690 and a skill system 625. A skill may be configured to execute with respect to NLU output data. For example, for an NLU hypothesis including a <GetWeather> intent, the system 120 (and more particularly the orchestrator component 630) may invoke a weather skill to determine and output weather information for a geographic location represented in a user profile or corresponding to a location of the device 110 that captured the corresponding natural language user input. For further example, for an NLU hypothesis including a <BookRide> intent, the system 120 (and more particularly the orchestrator component 630) may invoke a taxi skill to book a requested ride. In another example, for an NLU hypothesis including a <BuyPizza> intent, the system 120 (and more particularly the orchestrator component 630) may invoke a restaurant skill to place an order for a pizza. A skill may operate in conjunction between the system 120 and other devices, such as the device 110, restaurant electronic ordering systems, taxi electronic booking systems, etc. in order to complete certain functions. Inputs to a skill may come from speech processing interactions or through other interactions or input sources.

A skill may be associated with a domain, a non-limiting list of which includes a smart home domain, a music domain, a video domain, a weather domain, a communications domain, a flash briefing domain, a shopping domain, and a custom domain.

The system 120 may include a summary component 665 that may be configured to retrieve stored summaries corresponding to an entity(ies), rank the retrieved summaries, and provide the ranked summaries or a top scoring summary as being responsive to input data (e.g., a user input). Details on the summary component 665 are provided in relation to FIG. 8.

The system 120 may include a TTS component 680 that determine audio data (e.g., synthesized speech) from text data using one or more different methods. Text data input to the TTS component 680 may come from a skill, the orchestrator component 630, or another component of the system 120.

In one method of synthesis called unit selection, the TTS component 680 matches text data against a database of recorded speech. The TTS component 680 selects matching units of recorded speech and concatenates the units together to form audio data. In another method of synthesis called parametric synthesis, the TTS component 680 varies parameters such as frequency, volume, and noise to determine audio data including an artificial speech waveform. Parametric synthesis uses a computerized voice generator, sometimes called a vocoder.

The system 120 may include a user recognition component 695. The user recognition component 695 may recognize one or more users using various data. The user recognition component 695 may take as input the audio data 611. The user recognition component 695 may perform user recognition by comparing speech characteristics, in the audio data 611, to stored speech characteristics of users (e.g., stored speech characteristics associated with user profile identifiers associated with the device 110 that determined the audio data 611). The user recognition component 695 may additionally or alternatively perform user recognition by comparing biometric data (e.g., fingerprint data, iris data, retina data, etc.), received by the system 120 in correlation with a natural language user input, to stored biometric data of users (e.g., stored biometric data associated with user profile identifiers associated with the device 110 that determined the audio data 611 or otherwise captured a user input). The user recognition component 695 may additionally or alternatively perform user recognition by comparing image data (e.g., including a representation of at least a feature of a user), received by the system 120 in correlation with a natural language user input, with stored image data including representations of features of different users (e.g., stored image data associated with user profile identifiers associated with the device 110 that determined the audio data 611 or otherwise captured a user input). The user recognition component 695 may perform other or additional user recognition processes, including those known in the art. For a particular user input, the user recognition component 695 may perform processing with respect to stored data of users associated with the device 110 that captured the user input.

The user recognition component 695 determines whether a user input originated from a particular user. For example, the user recognition component 695 may determine a first value representing a likelihood that a user input originated from a first user, a second value representing a likelihood that user input originated from a second user, etc. The user recognition component 695 may also determine an overall confidence regarding the accuracy of user recognition processing.

The user recognition component 695 may output a single user profile identifier corresponding to the most likely user that originated the user input. Alternatively, the user recognition component 695 may output multiple user profile identifiers (e.g., in the form of an N-best list) with respective values representing likelihoods of respective users originating the user input. The output of the user recognition component 695 may be used to inform NLU processing, processing performed by a skill, as well as processing performed by other components of the system 120 and/or other systems.

The system 120 may include profile storage 670. The profile storage 670 may include a variety of data related to individual users, groups of users, devices, etc. that interact with the system 120. As used herein, a “profile” refers to a set of data associated with a user, group of users, device, etc. The data of a profile may include preferences specific to the user, group of users, device, etc.; input and output capabilities of one or more devices; internet connectivity data; user bibliographic data; subscription data; as well as other data.

The profile storage 670 may include one or more user profiles. Each user profile may be associated with a different user profile identifier. Each user profile may include various user identifying data. Each user profile may also include preferences of the user. Each user profile may include one or more device identifiers, representing one or more devices registered to the user. Each user profile may include identifiers of skills that the user has enabled. When a user enables a skill, the user is providing the system 120 with permission to allow the skill to execute with respect to the user's natural language user inputs. If a user does not enable a skill, the system 120 may not invoke the skill to execute with respect to the user's natural language user inputs.

The profile storage 670 may include one or more group profiles. Each group profile may be associated with a different group profile identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, a user profile may include preferences unique from one or more other user profiles associated with the same group profile. A user profile may be a stand-alone profile or may be associated with a group profile. A group profile may be associated with (or include) one or more device profiles corresponding to one or more devices associated with the group profile.

The profile storage 670 may include one or more device profiles. Each device profile may be associated with a different device identifier/device profile identifier. A device profile may include various device identifying data, input/output characteristics, networking characteristics, etc. A device profile may also include one or more user profile identifiers, corresponding to one or more user profiles associated with the device profile. For example, a household device's profile may include the user profile identifiers of users of the household.

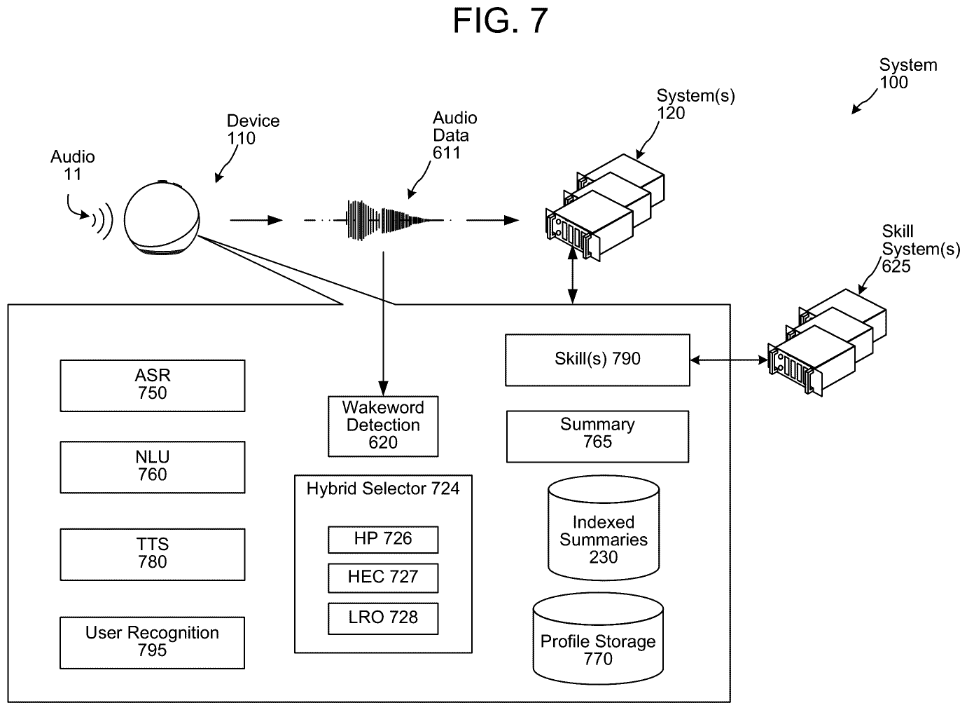

The foregoing describes illustrative components and processing of the system 120. In at least some embodiments, the device 110 may be configured to include some or all of the components, and perform some or all of the processing, of the system 120 described above. FIG. 7 illustrates such a configured device 110.

In at least some embodiments, the system 120 may receive the audio data 611 from the device 110, to recognize speech corresponding to a spoken input in the received audio data 611, and to perform functions in response to the recognized speech. In at least some embodiments, these functions involve sending directives (e.g., commands), from the system 120 to the device 110 (and/or other devices 110) to cause the device 110 to perform an action, such as output an audible response to the spoken input via a loudspeaker(s), and/or control secondary devices in the environment by sending a control command to the secondary devices.

Thus, when the device 110 is able to communicate with the system 120 over the network(s) 199, some or all of the functions capable of being performed by the system 120 may be performed by sending one or more directives over the network(s) 199 to the device 110, which, in turn, may process the directive(s) and perform one or more corresponding actions. For example, the system 120, using a remote directive that is included in response data (e.g., a remote response), may instruct the device 110 to output an audible response (e.g., using TTS processing performed by an on-device TTS component 780) to a user's question via a loudspeaker(s) of (or otherwise associated with) the device 110, to output content (e.g., music) via the loudspeaker(s) of (or otherwise associated with) the device 110, to display content on a display of (or otherwise associated with) the device 110, and/or to send a directive to a secondary device (e.g., a directive to turn on a smart light). It is to be appreciated that the system 120 may be configured to provide other functions in addition to those discussed herein, such as, without limitation, providing step-by-step directions for navigating from an origin location to a destination location, conducting an electronic commerce transaction on behalf of the user 5 as part of a shopping function, establishing a communication session (e.g., a video call) between the user 5 and another user, and so on.

As noted with respect to FIG. 6, the device 110 may include a wakeword detection component 620 configured to compare the audio data 611 to stored models used to detect a wakeword (e.g., “Alexa”) that indicates to the device 110 that the audio data 611 is to be processed for determining NLU output data (e.g., slot data that corresponds to a named entity, label data, and/or intent data, etc.). In at least some embodiments, a hybrid selector 724, of the device 110, may send the audio data 611 to the wakeword detection component 620. If the wakeword detection component 620 detects a wakeword in the audio data 611, the wakeword detection component 620 may send an indication of such detection to the hybrid selector 724. In response to receiving the indication, the hybrid selector 724 may send the audio data 611 to the system 120 and/or the ASR component 750. The wakeword detection component 620 may also send an indication, to the hybrid selector 724, representing a wakeword was not detected. In response to receiving such an indication, the hybrid selector 724 may refrain from sending the audio data 611 to the system 120, and may prevent the ASR component 750 from further processing the audio data 611. In this situation, the audio data 611 can be discarded.

The device 110 may conduct its own speech processing using on-device processing components, such as an ASR component 750 and an NLU 760, similar to the manner discussed above with respect to the ASR component 650 and the NLU component 660 of the system 120. The device 110 may also internally include, or otherwise have access to, other components such as one or more skill components 790 capable of executing commands based on NLU output data or other results determined by the device 110/system 120, a user recognition component 795 (configured to process in a similar manner to that discussed above with respect to the user recognition component 695 of the system 120), profile storage 770 (configured to store similar profile data to that discussed above with respect to the profile storage 670 of the system 120), or other components. In at least some embodiments, the profile storage 770 may only store profile data for a user or group of users specifically associated with the device 110. Similar to as described above with respect to FIG. 6, a skill component 790 may communicate with a skill system(s) 625. The device 110 may also include a summary component 765, similar to the summary component 665.

In at least some embodiments, the on-device language processing components may not have the same capabilities as the language processing components of the system 120. For example, the on-device language processing components may be configured to handle only a subset of the natural language user inputs that may be handled by the system 120. For example, such subset of natural language user inputs may correspond to local-type natural language user inputs, such as those controlling devices or components associated with a user's home. In such circumstances the on-device language processing components may be able to more quickly interpret and respond to a local-type natural language user input, for example, than processing that involves the system 120. If the device 110 attempts to process a natural language user input for which the on-device language processing components are not necessarily best suited, the language processing results determined by the device 110 may indicate a low confidence or other metric indicating that the processing by the device 110 may not be as accurate as the processing done by the system 120.

The hybrid selector 724, of the device 110, may include a hybrid proxy (HP) 726 configured to proxy traffic to/from the system 120. For example, the HP 726 may be configured to send messages to/from a hybrid execution controller (HEC) 727 of the hybrid selector 724. For example, command/directive data received from the system 120 can be sent to the HEC 727 using the HP 726. The HP 726 may also be configured to allow the audio data 611 to pass to the system 120 while also receiving (e.g., intercepting) this audio data 611 and sending the audio data 611 to the HEC 727.

In at least some embodiments, the hybrid selector 724 may further include a local request orchestrator (LRO) 728 configured to notify the ASR component 750 about the availability of new audio data 611 that represents user speech, and to otherwise initiate the operations of on-device language processing when new audio data 611 becomes available. In general, the hybrid selector 724 may control execution of on-device language processing, such as by sending “execute” and “terminate” events/instructions. An “execute” event may instruct a component to continue any suspended execution (e.g., by instructing the component to execute on a previously-determined intent in order to determine a directive). Meanwhile, a “terminate” event may instruct a component to terminate further execution, such as when the device 110 receives directive data from the system 120 and chooses to use that remotely-determined directive data.

Thus, when the audio data 611 is received, the HP 726 may allow the audio data 611 to pass through to the system 120 and the HP 726 may also input the audio data 611 to the on-device ASR component 750 by routing the audio data 611 through the HEC 727 of the hybrid selector 724, whereby the LRO 728 notifies the ASR component 750 of the audio data 611. At this point, the hybrid selector 724 may wait for response data from either or both of the system 120 or the on-device language processing components. However, the disclosure is not limited thereto, and in some examples the hybrid selector 724 may send the audio data 611 only to the on-device ASR component 750 without departing from the disclosure. For example, the device 110 may process the audio data 611 on-device without sending the audio data 611 to the system 120.

The on-device ASR component 750 is configured to receive the audio data 611 from the hybrid selector 724, and to recognize speech in the audio data 611, and the on-device NLU component 760 is configured to determine a user intent from the recognized speech, and to determine how to act on the user intent by generating NLU output data which may include directive data (e.g., instructing a component to perform an action). Such NLU output data may take a form similar to that as determined by the NLU component 660 of the system 120. In some cases, a directive may include a description of the intent (e.g., an intent to turn off {device A}). In some cases, a directive may include (e.g., encode) an identifier of a second device(s), such as kitchen lights, and an operation to be performed at the second device(s). Directive data may be formatted using Java, such as JavaScript syntax, or JavaScript-based syntax. This may include formatting the directive using JSON. In at least some embodiments, a device-determined directive may be serialized, much like how remotely-determined directives may be serialized for transmission in data packets over the network(s) 199. In at least some embodiments, a device-determined directive may be formatted as a programmatic API call with a same logical operation as a remotely-determined directive. In other words, a device-determined directive may mimic a remotely-determined directive by using a same, or a similar, format as the remotely-determined directive.

An NLU hypothesis (output by the NLU component 760) may be selected as usable to respond to a natural language user input, and local response data may be sent (e.g., local NLU output data, local knowledge base information, internet search results, and/or local directive data) to the hybrid selector 724, such as a “ReadyToExecute” response. The hybrid selector 724 may then determine whether to use directive data from the on-device components to respond to the natural language user input, to use directive data received from the system 120, assuming a remote response is even received (e.g., when the device 110 is able to access the system 120 over the network(s) 199), or to determine output audio requesting additional information from the user 5.

The device 110 and/or the system 120 may associate a unique identifier with each natural language user input. The device 110 may include the unique identifier when sending the audio data 611 to the system 120, and the response data from the system 120 may include the unique identifier to identify which natural language user input the response data corresponds.

In at least some embodiments, the device 110 may include, or be configured to use, one or more skill components 790 that may work similarly to the skill component(s) 690 implemented by the system 120. The skill component(s) 790 may correspond to one or more domains that are used in order to determine how to act on a spoken input in a particular way, such as by outputting a directive that corresponds to the determined intent, and which can be processed to implement the desired operation. The skill component(s) 790 installed on the device 110 may include, without limitation, a smart home skill component (or smart home domain) and/or a device control skill component (or device control domain) to execute in response to spoken inputs corresponding to an intent to control a second device(s) in an environment, a music skill component (or music domain) to execute in response to spoken inputs corresponding to a intent to play music, a navigation skill component (or a navigation domain) to execute in response to spoken input corresponding to an intent to get directions, a shopping skill component (or shopping domain) to execute in response to spoken inputs corresponding to an intent to buy an item from an electronic marketplace, and/or the like.

Additionally or alternatively, the device 110 may be in communication with one or more skill systems 625. For example, a skill system 625 may be located in a remote environment (e.g., separate location) such that the device 110 may only communicate with the skill system 625 via the network(s) 199. However, the disclosure is not limited thereto. For example, in at least some embodiments, a skill system 625 may be configured in a local environment (e.g., home server and/or the like) such that the device 110 may communicate with the skill system 625 via a private network, such as a local area network (LAN).

As used herein, a “skill” may refer to a skill component 790, a skill system 625, or a combination of a skill component 790 and a skill system 625.

FIG. 8 is a conceptual diagram showing how the system 120 may determine summarized text data in response to input data 802, according to embodiments of the present disclosure. The input data 802 may be data determined by one or more components of the system 100, for example, the components shown in FIG. 6. In example embodiments, the input data 802 may be determined by processing a user input provided by the user 5 to the device 110. For example, the user 5 may speak a natural language input, and the system 100 may process the audio data corresponding to the spoken natural language input to determine the input data 802 (e.g., NLU output data). The input data 802 may be sent to the skill component 690 (shown in FIG. 6) or the skill component 790 (shown in FIG. 7) for further processing. In some embodiments, the input data 802 may include intent data corresponding to the user input, entity data corresponding to one or more entities represented in the user input, and/or other data corresponding to the user input. The skill component 690 may send a request 810 for summary data to the summary component 665 (shown in FIG. 6) or the summary component 765 (shown in FIG. 7). The request 810 for summary data may include data representing an entity(ies) for which the skill component 690 is requesting the summary for. In some embodiments, the request 810 for summary data may include the intent data and the entity data included in the input data 802.

The summary component 665/765 may retrieve multiple summarized text data 222, 224 from the indexed summaries storage 230 based on the one or more entities indicated in the request 810 for summary data. For example, the summary component 665/765 may perform a search (e.g., an Elastic search) of the indexed summaries storage 230 using the entity as keywords (e.g., as separate keywords, or combined keywords). The summarized text data 222, 224 may represent summaries that include the keywords or that correspond to the keywords. Since the indexed summaries storage 230 stores summaries for various different entities, multiple summaries may be retrieved from the indexed summaries storage 230 based on the keywords.

The summary component 665/765 may include a ranker component 820 configured to rank the summarized text data 222, 224 retrieved from the indexed summaries storage 230. The ranker component 820 may employ one or more machine learning algorithms, for example, a logistic regression model, a neural network or other types of models. The ranker component 820 may determine a score for each of the summarized text data 222, 224 received at the summary component 665/765. The ranker component 820 may determine a score based on how responsive the respective summarized text data 222, 224 is to the input data 802. The ranker component 820 may generate the score based on processing the intent data and the entity data included in the request for summary 810. In some embodiments, the ranker component 820 may generate the score based on the score stored in the indexed summaries storage 230 that is generated as the scored text data 332 shown in FIGS. 3A and 3B.

Other data that the ranker component 820 may process in generating the score include, but are not limited to: a search score indicating how relevant the summary based on the search of the indexed summaries storage 230; frequency of one or more of the words of the user input within the summary; exact matching phrases of the user input within the summary; partial matching phrases of the user input within the summary; frequency of the entity in the summary; news (or other type) of source from which the summary is generated; frequency of personal words (e.g., I, me, my, etc.) in the summary; frequency of profanity words in the summary; summary includes other data (e.g., image, web links, etc.); summary has a title; number of redundant sentences or phrases; language diversity (e.g., number of unique sentences or number of unique words); geographic location of the user 5; any geographic location included in the user input; and device type of the device 110. The ranker component 820 may process the summarized text data 222, 224 with respect to the foregoing other data to determine the score.

In some embodiments, the summary component 665/765 may provide a ranked list of summarized text data 830 to the skill component 690/790 in response to the request for summary 810. Each of the ranked summarized text data 830 may be associated with the corresponding score determined by the ranker component 820, and the ranked summarized text data 830 may be determined based on these scores. The ranked summarized text data 830 may be a subset of the summarized text data 222, 224, based on the respective scores (generated by the ranker component 820) satisfying a threshold score. The ranked summarized text data 830 may be a number of top scoring (e.g., the top five scoring) summarized text data 222, 224 based on the scores generated by the ranker component 820. In this embodiment, the skill 690/790 may select a summary from the ranked summarized text data 830 to determine output data 840 responsive to the input data 802.

In some embodiments, the summary component 665/765 may select a summary from the ranked summarized text data 830, and may send selected summarized text data 832, corresponding to the selected summary, to the skill 690/790. The selected summarized text data 832 may be the top scoring summary from the ranked summarized text data 830. In this embodiment, the skill 690/790 may determine the output data 840 using the selected summarized text data 832.

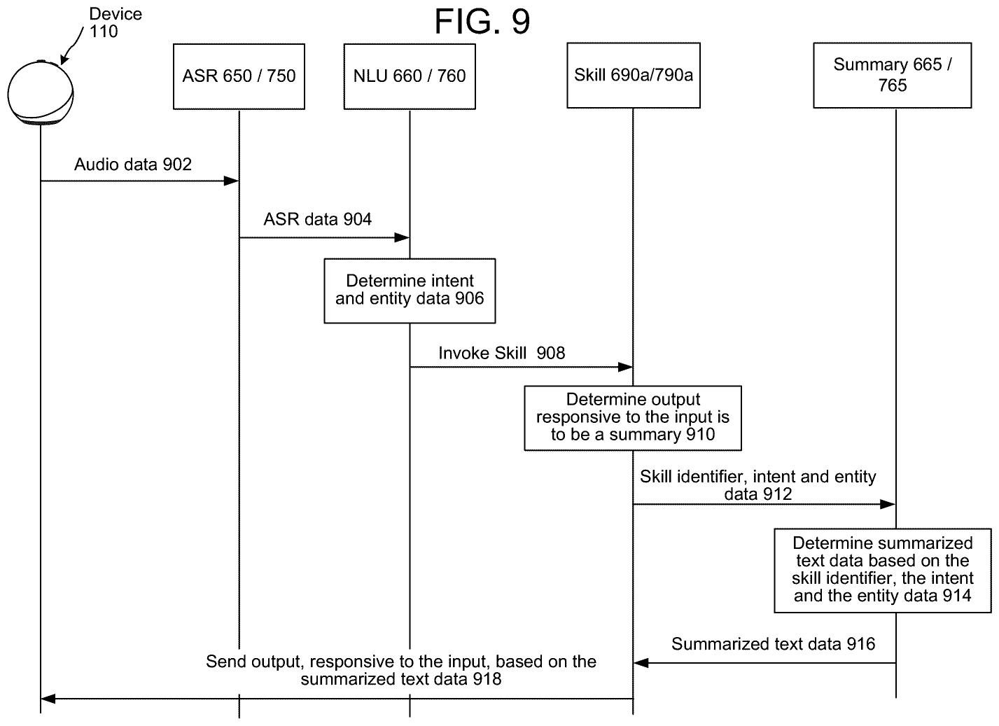

FIG. 9 is a signal flow diagram illustrating how a user input may be processed by the components of the device 110 or the system(s) 120, according to embodiments of the present disclosure. The device 110 may capture audio data representing a spoken natural language input. For example, the user 5 may say “tell me about [celebrity name]” or “what's new in [topic]?” In another example, the user 5 may say “start my daily news briefing” and request a news briefing, which may be based on (depending on system configuration), current news or currently trending topics/entities in the news. In yet another example, the user 5 may be engaged in an on-going dialog (exchange of user inputs and system-generated responses), and the user input corresponding to the audio data may be an input during the dialog.

The device 110 may send (902) the audio data, corresponding to the user input, to the ASR component 650/750 to perform ASR processing and determine ASR data corresponding to the audio data 902 as described above in connection with FIG. 6. The ASR component 650/750 may send (904) the ASR data to the NLU component 660/760 to perform NLU processing. The NLU component 660/760 may determine (906) intent and entity data corresponding to the audio data, as described above in connection with FIG. 6. Based at least on the intent data, the NLU component 660/760 may select the skill component 690a/790a as being capable of processing the user input, and may invoke (908) the skill component 690a/790a. In some embodiments, the NLU component 660/760 may send the intent data and the entity data to the skill component 690a/790a. The skill component 690a/790a may determine (910) that an output responsive to the input is to be a summary. For example, certain intents, corresponding to the user input, may indicate that the user 5 is requesting a summary or that a response including a summary may be beneficial to the user 5. Such example intents include, but are not limited to, {ReceiveNewsIntent}, {ReceiveInformation}, {QuestionAnswerIntent}, etc.

The skill component 690a/790a may send (912) a skill identifier, the intent data and the entity data to the summary component 665/765. The skill identifier may be an identifier corresponding to the skill 690a/790a. The summary component 665/765 may determine (914) summarized text based at least in part on the skill identifier, the intent data and the entity data, as described above in connection to FIG. 8. The summary component 665/765 may send (916) summarized text data to the skill component 690a/790a. The skill component 690a/790a may determine and send (918) an output, responsive to the input, based on the summarized text data.

In some embodiments, the output may be synthesized speech determined using the summarized text data and the TTS processing component 680/780. The device 110 may output audio representing the synthesized speech and providing the summary to the user 5 in response to the user input. In some embodiments, the output may be text data (and other data, such as image data, video data, etc.) based on the summarized text data, and may be displayed at the device 110 in response to the user input. In yet other embodiments, the output may be a message (e.g., email, SMS, etc.) or a notification (e.g., push notification) that includes text data (and other data, such as image data, video data, etc.) based on the summarized text data.

In some embodiments, the skill component 690a/790a may determine an output type based on the summarized text data. For example, a lengthy summary may be provided to the user 5 as displayed text, a message or a notification. In another example, a shorter summary may be provided to the user 5 as synthesized speech.

Machine learning (ML) is a valuable computing technique that allows computing systems to learn techniques for solving complex problems without needing an explicit algorithm for the computing system to follow. ML may use a trained model that consists of internally configured operations that can manipulate a particular type of input data to determine a desired result. Trained models are used in many computing tasks such as computer vision, speech processing, predictive analyses, and many more.

Trained models come in a variety of forms including trained classifiers, Support Vector Machines (SVMs), neural networks (such as deep neural networks (DNNs), recurrent neural networks (RNNs), or convolutional neural networks (CNNs)), random forests, isolation forests, and others. As an example, a neural network typically includes an input layer, an output layer and one or more intermediate hidden layers where the input layer is configured to take in a certain kind of data and the output layer is configured to output the desired kind of data resulting from the network and the hidden layer(s) perform a variety of functions to generate output data from the input data.

Various techniques may be used to train ML models including backpropagation, statistical learning, supervised learning, semi-supervised learning, stochastic learning, or other known techniques. In supervised learning a model may be configured to infer a function from labeled training data. Thus a computing system may use training data in the form of training examples that provide examples of the kinds of input data the model will be configured to process at runtime as well as an accompanying “ground truth” for each training example. The ground truth provides the correct response for the respective training example, thus providing a complete example that can be used to train the model. Other data that may be used to train a model may include training parameters such as error functions, weights or other data that can be used to guide the training of a model.

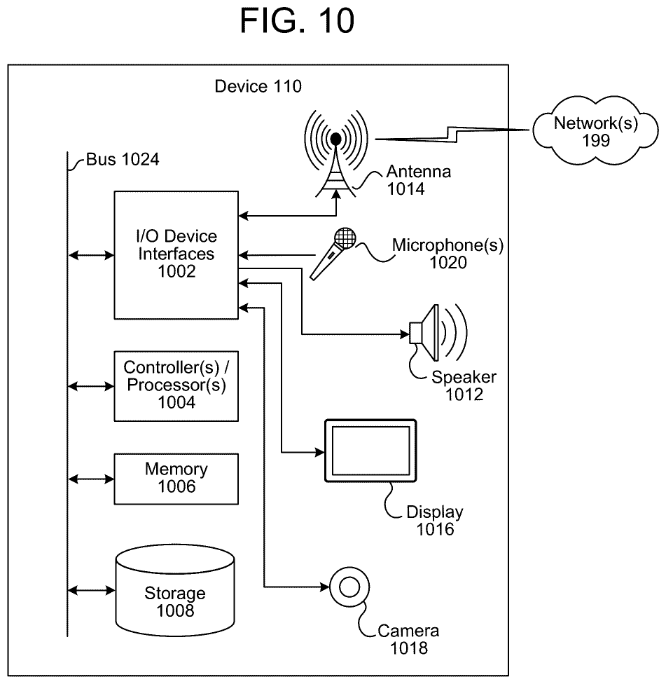

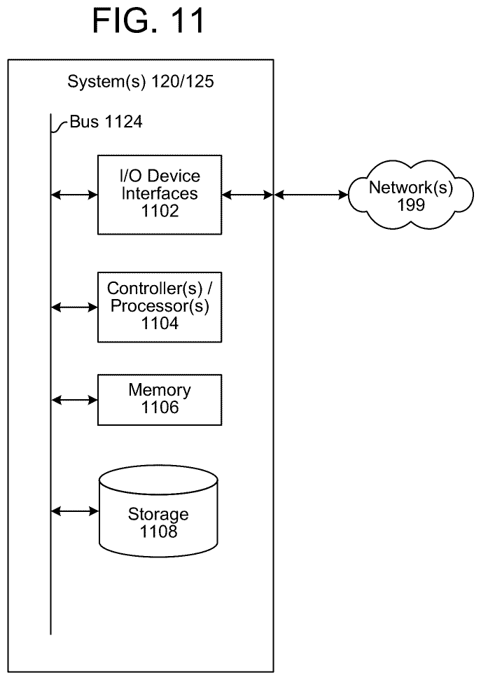

FIG. 10 is a block diagram conceptually illustrating example components of a device 110 according to the present disclosure. FIG. 11 is a block diagram conceptually illustrating example components of a system, such as the system 120 or a skill system 625. A system (120/625) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The system 120 may be configured to operate using one or more of a client-server model, a computer bureau model, grid computing techniques, fog computing techniques, mainframe techniques, utility computing techniques, a peer-to-peer model, sandbox techniques, or other computing techniques.

Multiple systems (120/625) may be included in the system 100 of the present disclosure, such as one or more systems 120 for performing ASR processing, one or more systems 120 for performing NLU processing, and one or more skill systems 625, etc. In operation, each of these systems may include computer-readable and computer-executable instructions that reside on the respective device (120/625), as will be discussed further below.

Each of these devices (110/120/625) may include one or more controllers/processors (1004/1104), which may each include a central processing unit (CPU) for processing data and computer-readable instructions, and a memory (1006/1106) for storing data and instructions of the respective device. The memories (1006/1106) may individually include volatile random access memory (RAM), non-volatile read only memory (ROM), non-volatile magnetoresistive memory (MRAM), and/or other types of memory. Each device (110/120/625) may also include a data storage component (1008/1108) for storing data and controller/processor-executable instructions. Each data storage component (1008/1108) may individually include one or more non-volatile storage types such as magnetic storage, optical storage, solid-state storage, etc. Each device (110/120/625) may also be connected to removable or external non-volatile memory and/or storage (such as a removable memory card, memory key drive, networked storage, etc.) through respective input/output device interfaces (1002/1102).

Computer instructions for operating each device (110/120/625) and its various components may be executed by the respective device's controller(s)/processor(s) (1004/1104), using the memory (1006/1106) as temporary “working” storage at runtime. A device's computer instructions may be stored in a non-transitory manner in non-volatile memory (1006/1106), storage (1008/1108), or an external device(s). Alternatively, some or all of the executable instructions may be embedded in hardware or firmware on the respective device in addition to or instead of software.

Each device (110/120/625) includes input/output device interfaces (1002/1102). A variety of components may be connected through the input/output device interfaces (1002/1102), as will be discussed further below. Additionally, each device (110/120/625) may include an address/data bus (1024/1124) for conveying data among components of the respective device. Each component within a device (110/120/625) may also be directly connected to other components in addition to (or instead of) being connected to other components across the bus (1024/1124).

Referring to FIG. 10, the device 110 may include input/output device interfaces 1002 that connect to a variety of components such as an audio output component such as a speaker 1012, a wired headset or a wireless headset (not illustrated), or other component capable of outputting audio. The device 110 may also include an audio capture component. The audio capture component may be, for example, a microphone 1020 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The device 110 may additionally include a display 1016 for displaying content. The device 110 may further include a camera 1018.

Via antenna(s) 1014, the input/output device interfaces 1002 may connect to a network(s) 199 via a wireless local area network (WLAN) (such as WiFi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (1002/1102) may also include communication components that allow data to be exchanged between devices such as different physical servers in a collection of servers or other components.

The components of the device 110, the system 120, and/or a skill system 625 may include their own dedicated processors, memory, and/or storage. Alternatively, one or more of the components of the device 110, the system 120, and/or a skill system 625 may utilize the I/O interfaces (1002/1102), processor(s) (1004/1104), memory (1006/1106), and/or storage (1008/1108) of the device(s) 110, system 120, or the skill system 625, respectively. Thus, the ASR component 650 may have its own I/O interface(s), processor(s), memory, and/or storage; the NLU component 660 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the device 110, the system 120, and a skill system 625, as described herein, are illustrative, and may be located as a stand-alone device or may be included, in whole or in part, as a component of a larger device or system.

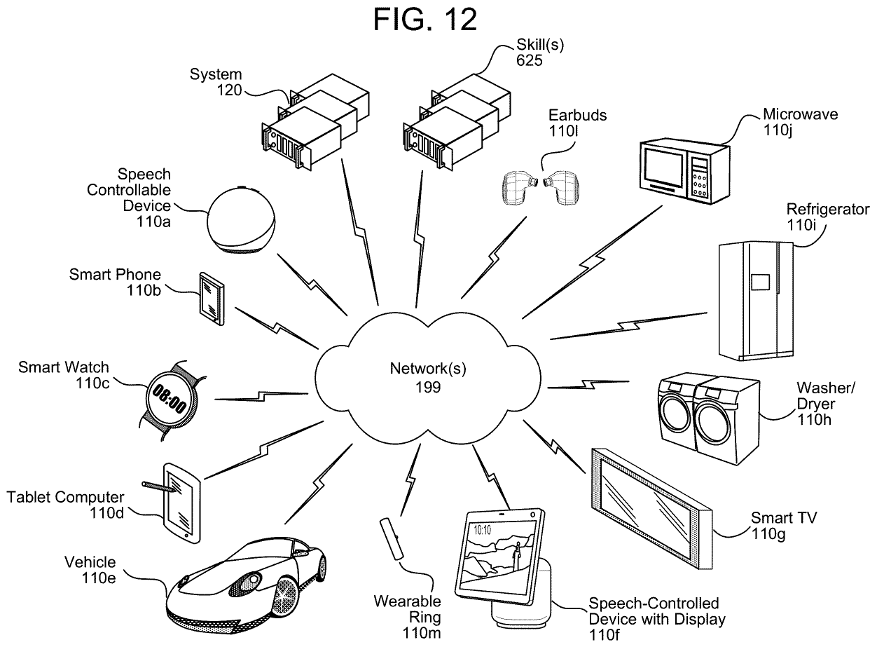

As illustrated in FIG. 12, multiple devices (110a-1101) may process as part of the system 100. The network(s) 199 may include a local or private network or may include a wide network such as the Internet. Devices may be connected to the network(s) 199 through either wired or wireless connections. For example, the system 100 may include a speech-controlled device(s) 110a, a smart phone(s) 110b, a smart watch(s) 110c, a tablet computer(s) 110d, a vehicle(s) 110e, a speech-controlled display device(s) with a display 110f, a smart television(s) 110g, a washer(s)/dryer(s) 110h, a refrigerator(s) 110i, a microwave(s) 110j, earbuds 1101, and/or a wearable ring(s) 110m.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware, such as an acoustic front end (AFE), which comprises, among other things, analog and/or digital filters (e.g., filters configured as firmware to a digital signal processor (DSP)).

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
receiving first data;
receiving user input data indicating a maximum number of consecutive words allowed to be copied from the first data when generating second data;
generating, using a trained model, the second data based on the first data and the maximum number of consecutive words allowed to be copied; and
storing the second data in a data storage.

2. The computer-implemented method of claim 1, wherein the first data comprises a plurality of documents.

3. The computer-implemented method of claim 1, wherein generating the second data comprises:
determining a first portion of the second data to be a sequence of words from the first data, wherein the first portion of the second data corresponds to the maximum number of consecutive words; and
after determining the first portion, determining a next word of the second data to be different than a word following the sequence of words in the first data.

4. The computer-implemented method of claim 3, further comprising determining the next word to be semantically similar to a word following the sequence of words in the first data.

5. The computer-implemented method of claim 1, wherein generating the second data comprises:
determining a first portion of the second data to be a sequence of words from the first data, wherein the first portion of the second data corresponds to the maximum number of consecutive words; and
after determining the first portion, determining a next portion of the second data to include a second portion of the first data.

6. The computer-implemented method of claim 1, wherein generating the second data comprises applying a penalty function to words selected for the second data.

7. The computer-implemented method of claim 6, wherein the penalty function increases as a number of consecutive words in the second data copied from the first data increases.

8. The computer-implemented method of claim 1, wherein generating the second data comprises selecting a next word for the second data based on a penalty function applied to a prior word in the second data.

9. The computer-implemented method of claim 1, wherein the trained model comprises an encoder and a decoder.

10. The computer-implemented method of claim 1, further comprising:
receiving audio data representing a spoken natural language input corresponding to an entity;
determining, from the data storage, the second data based on the second data corresponding to the entity;
determining, from the data storage, third data corresponding to the entity; and
presenting the second data or the third data.

11. A computing system comprising:
at least one processor; and
at least one memory comprising instructions that, when executed by the at least one processor, cause the computing system to:
receive first data;
receive user input data indicating a maximum number of consecutive words allowed to be copied from the first data when generating second data;
generate, using a trained model, the second data based on the first data and the maximum number of consecutive words allowed to be copied; and
store the second data in a data storage.

12. The computing system of claim 11, wherein the first data comprises a plurality of documents.

13. The computing system of claim 11, wherein the instructions for generating the second data further comprise instructions that, when executed by the at least one processor, cause the system computing to:
determine a first portion of the second data to be a sequence of words from the first data, wherein the first portion of the second data corresponds to the maximum number of consecutive words; and
after determining the first portion, determine a next word of the second data to be different than a word following the sequence of words in the first data.

14. The computing system of claim 13, wherein the at least one memory further comprises instructions that, when executed by the at least one processor, cause the system computing to determine the next word to be semantically similar to a word following the sequence of words in the first data.

15. The computing system of claim 11, wherein the instructions for generating the second data further comprise instructions that, when executed by the at least one processor, cause the system computing to:
determine a first portion of the second data to be a sequence of words from the first data, wherein the first portion of the second data corresponds to the maximum number of consecutive words; and
after determining the first portion, determine a next portion of the second data to include a second portion of the first data.

16. The computing system of claim 11, wherein the instructions for generating the second data further comprise instructions that, when executed by the at least one processor, cause the system computing to apply a penalty function to words selected for the second data.

17. The computing system of claim 16, wherein the penalty function increases as a number of consecutive words in the second data copied from the first data increases.

18. The computing system of claim 11, wherein the instructions for generating the second data further comprise instructions that, when executed by the at least one processor, cause the system computing to select a next word for the second data based on a penalty function applied to a prior word in the second data.

19. The computing system of claim 11, wherein the trained model comprises an encoder and a decoder.

20. The computing system of claim 11, wherein the at least one memory further comprises instructions that, when executed by the at least one processor, cause the system computing to:
receive audio data representing a spoken natural language input corresponding to an entity;
determine, from the data storage, the second data based on the second data corresponding to the entity;
determine, from the data storage, third data corresponding to the entity; and
presenting the second data or the third data.
